(19) United States
(12) Patent Application Publication
(10) Pub. No.: US 2021/0245472 A1
(43) Pub. Date: Aug. 12, 2021

(54) FLAT COMPOSITE FOR PRODUCING DIMENSIONALLY STABLE FOOD CONTAINERS, CONTAINING A POLYMER LAYER WITH A POLYESTER AND AN ISOTROPIC MODULUS OF ELASTICITY

(71) Applicant: SIG TECHNOLOGY AG, Neuhausen am Rheinfall (CH)

(72) Inventors: Dr. Daniel Heinze, Linnich (DE); Marielle Schloemer, Geilenkirchen (DE)

(21) Appl. No.: 17/264,484

(22) PCT Filed: Jul. 26, 2019
(86) PCT No.: PCT/EP2019/070164

§ 371 Date: Jan. 29, 2021

(30) Foreign Application Priority Data
Jul. 31, 2018 (DE) 10 2018 212 797.2

(51) Int. Cl. B32B 7/022; B32B 1/02; B32B 7/03; B32B 27/30; B32B 27/32; B32B 27/36; B32B 27/08; B65B 3/02; B65B 3/04; B65B 7/20; B65D 65/40

(52) U.S. Cl. CPC B32B 7/022; B32B 2307/706; B32B 7/03; B32B 27/306; B32B 27/32; B32B 27/36; B32B 27/08; B65B 3/025; B65B 3/04; B65B 7/20; B65D 65/40; B32B 2439/70; B32B 2307/7244; B32B 2307/51; B32B 2250/04; B32B 2250/24; B32B 2307/72; B32B 1/02

(57) ABSTRACT

The invention relates to a sheetlike composite comprising, as mutually superposed layers in a direction from an outer face of the sheetlike composite to an inner face of the sheetlike composite,
a) a carrier layer, and
b) a barrier layer;
   wherein the sheetlike composite additionally comprises a polymer layer P, wherein the polymer layer P
a. comprises a polyester,
b. extends two-dimensionally within a layer plane,
c. has a first modulus of elasticity in a first layer direction which lies in the layer plane, and
d. has a further modulus of elasticity in a further layer direction which lies in the layer plane and is perpendicular to the first layer direction;
   wherein a ratio of the first modulus of elasticity to the further modulus of elasticity is within a range from 0.81 to 1.19. The invention further relates to methods of producing a sheetlike composite, a container precursor and a container, and to the aforementioned method products; to a container precursor and a container each comprising at least one sheetlike region of the sheetlike composite; and to uses of the sheetlike composite, of an extruder, of a chain modifier, of a mixture, of a base polymer, and of polyesters.

The present invention relates to a sheetlike composite comprising, as mutually superposed layers in a direction from an outer face of the sheetlike composite to an inner face of the sheetlike composite,
a) a carrier layer, and
b) a barrier layer;
   wherein the sheetlike composite additionally comprises a polymer layer P, wherein the polymer layer P
a. comprises a polyester,
b. extends two-dimensionally within a layer plane,
c. has a first modulus of elasticity in a first layer direction which lies in the layer plane, and
d. has a further modulus of elasticity in a further layer direction which lies in the layer plane and is perpendicular to the first layer direction;
   wherein a ratio of the first modulus of elasticity to the further modulus of elasticity is within a range from 0.81 to 1.19. The invention further relates to methods of producing a sheetlike composite, a container precursor and a container, and to the aforementioned method products; to a container precursor and a container each including at least one sheetlike region of the sheetlike composite; and to uses of the sheetlike composite, of an extruder, of a chain modifier, of a mixture, of a base polymer, and of polyesters.

For some time, food and drink products, whether they be food and drink products for human consumption or else animal feed products, have been preserved by storing them either in a can or in ajar closed by a lid. In this case, the shelf life can be increased firstly by sterilizing the food or drink product and the container, here the jar or can, separately and to the greatest possible extent in each case, and then introducing the food or drink product into the container and closing the container. However, these measures for increasing the shelf life of food and drink products, which have been tried and tested over a long period, have a series of disadvantages, for example the need for another sterilization later on. Cans and jars, because of their essentially cylindrical shape, have the disadvantage that very dense and space-saving storage is not possible. Moreover, cans and jars have considerable intrinsic weight, which leads to increased energy expenditure in transport. In addition, production of glass, tinplate or aluminum, even when the raw materials used for this purpose are recycled, necessitates quite a high expenditure of energy. In the case of jars, an additional aggravating factor is elevated expenditure on transport. The jars are usually prefabricated in a glass factory and then have to be transported to the facility where the food and drink products are dispensed with the use of considerable transport volumes. Furthermore, jars and cans can be opened only with considerable expenditure of force or with the aid of tools and hence in a rather laborious manner. In the case of cans, there is a high risk of injury arising from sharp edges that occur on opening. In the case of jars, there are recurrent instances of broken glass getting into the food or drink product in the course of filling or opening of the filled jars, which in the worst case can lead to internal injuries when the food or drink product is consumed. In addition, both cans and jars have to be labeled for identification and promotion of the food or drink product contents. The jars and cans cannot readily be printed directly with information and promotional messages. In addition to the actual printing, a substrate for that purpose, a paper or a suitable film, is thus needed, as is a securing means, an adhesive or a sealant.

Other packaging systems for storing food and drink products over a long period with minimum impairment are known from the prior art. These are containers produced from sheetlike composites—frequently also referred to as laminates. Sheetlike composites of this kind are frequently constructed from a thermoplastic polymer layer, a carrier layer usually consisting of cardboard or paper which imparts dimensional stability to the container, an adhesion promoter layer, a barrier layer and a further polymer layer, as disclosed inter alia in WO 90/09926 A2. Since the carrier layer imparts dimensional stability to the container manufactured from the laminate, these containers, by contrast with film bags, can be regarded as a further development of the aforementioned jars and cans.

These laminate containers already have many advantages over the conventional jars and cans. Nevertheless, there are opportunities for improvement in the case of these packaging systems too. For instance, there is a great need to make the laminate containers more environmentally friendly. More particularly, there is a drive to produce the polymer layers of laminates from what are called biopolymers in a maximum proportion. It is a feature of biopolymers that they are not obtained from fossil raw materials, but obtained from renewable raw materials or come from recycling. A method which is known in the art and is considered to be particularly advantageous for production of the polymer layers of the laminates is the layer extrusion method. Also known in the prior art is the use of biopolyolefins, for example biopolyethylene, for production of polymer layers of laminates by means of layer extrusion. However, the obtaining of these biopolyolefins is complex and hence costly as well. For example, biopolyethylene can be obtained from sugarcane. This means that biopolyolefin can be obtained from renewable raw materials, but it is neither biodegradable nor chemically recyclable. Thus, the known biopolyethylene is unconvincing with regard to its environmental compatibility.

Likewise known in the prior art are further biopolymers that are easier to produce than the above-discussed biopolyolefins. These further biopolymers include, for example, bio-PET, recycled PET (rPET), PLA and PHB. These biopolymers are chemically recyclable and, in the case of PLA and PHB, even biodegradable. However, these biopolymers that are highly desirable from the point of view of environmental compatibility have as such unfavorable processing properties. For instance, it is barely possible to use these biopolymers to produce polymer layers usable for laminates by means of layer extrusion. Attempts to use the further biopolymers for coating typically do not give homogeneous polymer films, but rather accumulations of more or less isolated polymer islands or strands that are unusable as polymer layer for laminates. In addition, it is barely possible to improve processing properties by forming blends since the aforementioned further biopolymers can barely be mixed with suitable polymers.

In general terms, it is an object of the present invention to at least partly overcome a disadvantage that arises from the prior art. It is a further object of the invention to provide an as environmentally friendly as possible laminate for production of dimensionally stable food or drink product containers, the polymer layers of which are obtainable by means of layer extrusion. In a further object of the invention, these polymer layers of the laminate are obtainable from polymers producible in an as much as possible simple and expensive manner. It is a further object of the invention to provide a laminate for production of dimensionally stable food or drink product containers which has at least one polymer layer obtainable by means of layer extrusion and which comprises a biopolymer producible in an as much as possible simple and inexpensive manner. It is a further object of the invention to provide one of the aforementioned advantageous laminates, wherein the polymers of the polymer layers show as good as possible processing properties on layer extrusion. Such processing properties are manifested, for example, in minimum neck-in, minimum edge waving and/or the forming of a polymer melt film of maximum homogeneity. It is a further object of the invention to provide one of the aforementioned advantageous laminates, wherein the laminate has an as good as possible printability with a color decoration, especially in an intaglio printing method, on its outside. It is a further object of the invention to provide one of the aforementioned advantageous laminates, wherein the laminate has an as good as possible adhesion between the layers of the laminate, especially a decoration on the outside and/or between a barrier layer and a carrier layer. It is a further object of the invention to provide a dimensionally stable laminate food or drink product container that shows maximum reliability of container stability in a moist environment. It is another object of the invention to provide a dimensionally stable laminate food or drink product container having maximum shelf life of the food or drink product stored therein, especially a fatty food or drink product. It is another object of the invention to provide a dimensionally stable laminate food or drink product container having as good as possible opening properties, especially in the case of opening with an opening aid. It is a further object of the invention to provide a production method for the aforementioned laminate and/or container.

A contribution to the at least partial achievement of at least one, preferably more than one, of the above objects is made by the independent claims. The dependent claims provide preferred embodiments which contribute to the at least partial achievement of at least one of the objects.

A contribution to the achievement of at least one of the objects of the invention is made by an embodiment 1 of a sheetlike composite 1 comprising, as mutually superposed layers, in a direction from an outer face of the sheetlike composite to an inner face of the sheetlike composite,
a) a carrier layer, and
b) a barrier layer;
   wherein the sheetlike composite additionally comprises a polymer layer P, wherein the polymer layer P
a. comprises a polyester,
b. extends two-dimensionally within a layer plane,
c. has a first modulus of elasticity in a first layer direction which lies in the layer plane, and
d. has a further modulus of elasticity in a further layer direction which lies in the layer plane and is perpendicular to the first layer direction;
   wherein a ratio of the first modulus of elasticity to the further modulus of elasticity is within a range from 0.81 to 1.19, preferably from 0.82 to 1.18, more preferably from 0.83 to 1.17, more preferably from 0.84 to 1.16, more preferably from 0.85 to 1.15, more preferably from 0.86 to 1.14, more preferably from 0.87 to 1.17, more preferably from 0.88 to 1.12, more preferably from 0.89 to 1.11, more preferably from 0.9 to 1.1, more preferably from 0.91 to 1.09, more preferably from 0.92 to 1.08, more preferably from 0.93 to 1.07, more preferably from 0.94 to 1.06, even more preferably from 0.95 to 1.05, most preferably from 0.96 to 1.04. The first and further modulus of elasticity are each determined by the method specified herein.

In one embodiment 2 of the invention, the sheetlike composite 1 is configured according to embodiment 1, wherein the polymer layer P has been obtained by melt coating of a sheetlike composite precursor. The sheetlike composite precursor preferably comprises the carrier layer. A polymer layer P obtained by means of melt coating of the sheetlike composite precursor should especially be distinguished from a polymer layer which has been provided as a prefabricated film and applied to or introduced into a composite precursor. What is meant by melt coating in this connection is that the polymer layer P is applied to the sheetlike composite precursor in at least partly, preferably fully, molten form and solidifies on the composite precursor. A preferred form of melt coating is melt extrusion coating. On viewing of a cross section through the layer sequence of the sheetlike composite under a scanning electron microscope (SEM), a polymer layer P obtained by means of melt coating, compared to a polymer film, frequently has layer boundaries with the adjacent layers that are less straight, i.e. rougher. This is specifically because the polymer layer P has been applied as a melt, i.e. in liquid form, which means that the melt adjusts to the roughness of the adjacent layers. A polymer layer made from a prefabricated film, by contrast, shows comparatively sharp and smooth boundaries with the adjacent layers. Since, in the case of a film, there is also no melting thereof on application or introduction into a composite, the film does not adjust to the surfaces of the adjacent layers, and so there are frequently cavities between the film and the adjacent layers. Especially at the high coating speeds customary in the technical field, the cavities described are frequently not filled completely with laminating agent, resulting in inclusions of gas between the film and the adjacent layers. These inclusions of gas are apparent from the cross section under SEM, and suggest a layer applied as a film.

In one embodiment 3 of the invention, the sheetlike composite 1 is configured according to its embodiment 1 or 2, wherein the first modulus of elasticity is within a range from 100 to 3000 MPa, preferably from 120 to 2500 MPa, more preferably from 140 to 2200 MPa.

In one embodiment 4 of the invention, the sheetlike composite 1 is configured according to any of its preceding embodiments, wherein the further modulus of elasticity is within a range from 100 to 3000 MPa, preferably from 140 to 2600 MPa, more preferably from 150 to 2250 MPa.

In one embodiment 5 of the invention, the sheetlike composite 1 is configured according to any of its preceding embodiments, wherein the polymer layer P comprises the polyester in a proportion within a range from 5% to 100% by weight, preferably from 10% to 100% by weight, more preferably from 20% to 100% by weight, more preferably from 30% to 100% by weight, more preferably from 40% to 100% by weight, more preferably from 50% to 100% by weight, more preferably from 55% to 100% by weight, more preferably from 60% to 100% by weight, more preferably from 65% to 100% by weight, more preferably from 70% to 100% by weight, more preferably from 75% to 100% by weight, more preferably from 80% to 100% by weight, more preferably from 85% to 100% by weight, more preferably from 90% to 100% by weight, more preferably from 92% to 100% by weight, more preferably from 94% to 100% by weight, even more preferably from 96% to 100% by weight, most preferably from 98% to 100% by weight, based in each case on the weight of the polymer layer P.

In one embodiment 6 of the invention, the sheetlike composite 1 is configured according to any of its preceding embodiments, wherein the polyester is a homopolymer. A homopolymer is a polymer formed from exactly one monomer. The homopolymer thus has exactly one repeat unit. Homopolymers contrast with copolymers that are formed from multiple different monomers.

In one embodiment 7 of the invention, the sheetlike composite 1 is configured according to any of its preceding embodiments, wherein a carbon content of the polymer layer P is biobased to an extent of at least 25%, more preferably to an extent of at least 30%, more preferably to an extent of at least 40%, more preferably to an extent of at least 50%, more preferably to an extent of at least 60%, more preferably to an extent of at least 70%, even more preferably to an extent of at least 80%, most preferably to an extent of at least 90%. The biobased fraction of the carbon content of the polymer layer P is determined by the method specified herein.

In one embodiment 8 of the invention, the sheetlike composite 1 is configured according to any of its preceding embodiments, wherein the polyester is obtainable from a renewable raw material. Obtaining the polyester from the renewable raw material preferably includes a chemical reaction, preferably a chain extension reaction, of a base polymer with a chain modifier, wherein the base polymer is obtainable from the renewable raw material. Additionally or alternatively, the obtaining of the polyester from the renewable raw material includes a method including monomer formation or a polymerization reaction or both, with preferably at least the monomer formation being effected in a fermentation. By the aforementioned method, the base polymer is preferably obtainable from the renewable raw material.

In one embodiment 9 of the invention, the sheetlike composite 1 is configured according to any of its preceding embodiments, wherein the polyester is a thermoplastic polymer.

In one embodiment 10 of the invention, the sheetlike composite 1 is configured according to any of its preceding embodiments, wherein the polymer layer P has a melting temperature of more than 145° C., preferably of more than 146° C., more preferably of more than 147° C., more preferably of more than 148° C., more preferably of more than 149° C., more preferably of more than 150° C., more preferably of more than 155° C., more preferably of more than 158° C., more preferably of more than 160° C., more preferably of more than 161° C., more preferably of more than 162° C., preferably of more than 163° C., more preferably of more than 164° C., more preferably of more than 165° C., more preferably of more than 166° C., more preferably of more than 167° C., more preferably of more than 168° C., more preferably of more than 169° C., more preferably of more than 170° C., more preferably more than 175° C., more preferably of more than 180° C., more preferably of more than 190° C., more preferably of more than 200° C., more preferably of more than 210° C., more preferably of more than 220° C., more preferably of more than 230° C., even more preferably of more than 235° C., most preferably of more than 238° C. The melting temperature is determined by the test method specified herein. The aforementioned melting temperature of the polymer layer P is preferably not more than 500° C., more preferably not more than 450° C., even more preferably not more than 400° C., even more preferably not more than 350° C., most preferably not more than 300° C. The polyester preferably has the abovementioned melting temperature of the polymer layer P.

In one embodiment 11 of the invention, the sheetlike composite 1 is configured according to any of its preceding embodiments, wherein the polyester is selected from the group consisting of a polylactide (PLA), a polyhydroxyalkanoate, and a polyalkylene terephthalate, or from a combination of at least two of these. A preferred polyhydroxyalkanoate (PHA) is a polyhydroxybutyrate (PHB). A preferred polyhydroxybutyrate is poly-(R)-3-hydroxybutyrate (P(3HB)). A preferred polyalkylene terephthalate is polybutylene terephthalate or polyethylene terephthalate (PET), particular preference being given to PET. A preferred PET is a recycled PET or a bio-PET or both. Bio-PET refers in this connection to a PET having a carbon content which is biobased to an extent of at least 25%, more preferably to an extent of at least 30%.

In one embodiment 12 of the invention, the sheetlike composite 1 is configured according to any of its preceding embodiments, wherein the polymer layer P has an intrinsic viscosity within a range from 0.5 to 1.0 dl/g, preferably from 0.6 to 1.0 dl/g, more preferably from 0.7 to 1.0 dl/g. The intrinsic viscosity of the polymer layer P is determined by the method described herein.

In one embodiment 13 of the invention, the sheetlike composite 1 is configured according to any of its preceding embodiments, wherein the polymer layer P is characterized by a melt flow rate (MFR) within a range from 2 to 15 g/10 min, preferably from 3 to 15 g/10 min, more preferably from 4 to 15 g/10 min, most preferably from 5 to 15 g/10 min.

In one embodiment 14 of the invention, the sheetlike composite 1 is configured according to any of its preceding embodiments, wherein the polymer layer P adjoins the carrier layer or the barrier layer or both. The polymer layer P preferably adjoins the carrier layer.

In one embodiment 15 of the invention, the sheetlike composite 1 is configured according to any of its preceding embodiments, wherein the sheetlike composite comprises an outer polymer layer, wherein the outer polymer layer superimposes the carrier layer on a side of the carrier layer remote from the barrier layer. In one embodiment, the sheetlike composite comprises the polymer layer P as the outer polymer layer. In a further preferred embodiment, the sheetlike composite comprises the outer polymer layer in addition to the polymer layer P.

In one embodiment 16 of the invention, the sheetlike composite 1 is configured according to any of its preceding embodiments, wherein the sheetlike composite comprises an inner polymer layer, wherein the inner polymer layer superimposes the barrier layer on a side of the barrier layer remote from the carrier layer. In one embodiment, the sheetlike composite comprises the polymer layer P as the inner polymer layer. In a further preferred embodiment, the sheetlike composite comprises the inner polymer layer in addition to the polymer layer P.

In one embodiment 17 of the invention, the sheetlike composite 1 is configured according to any of its preceding embodiments, wherein the carrier layer is superimposed on a side of the carrier layer remote from the barrier layer with an ink application. The ink application is preferably disposed on a side of the outer polymer layer facing the carrier layer or on a side of the outer polymer layer remote from the carrier layer. The ink application preferably forms a decoration of the sheetlike composite or of a container to be produced from the sheetlike composite. Preferably, the ink application comprises at least one colorant, more preferably at least 2, more preferably at least 3, more preferably at least 4, even more preferably at least 5, and most preferably at least 6, colorants. The aforementioned colorants preferably relate to different colors.

In one embodiment 18 of the invention, the sheetlike composite 1 is configured according to any of its preceding embodiments, wherein the sheetlike composite comprises a polymer interlayer between the carrier layer and the barrier layer. In one embodiment, the sheetlike composite comprises the polymer layer P as the polymer interlayer. In a further preferred embodiment, the sheetlike composite comprises the polymer interlayer in addition to the polymer layer P.

In one embodiment 19 of the invention, the sheetlike composite 1 is configured according to any of its preceding embodiments, wherein the sheetlike composite is a blank for production of a single, preferably closed, container.

In one embodiment 20 of the invention, the sheetlike composite 1 is configured according to any of its preceding embodiments, wherein the carrier layer has at least one hole. A preferred hole has a diameter of at least 4 mm, more preferably at least 5 mm, most preferably at least 9 mm.

In one embodiment 21 of the invention, the sheetlike composite 1 is configured according to its embodiment 20, wherein the hole is covered at least by the barrier layer as hole-covering layer. Preferably, the hole is further covered by a layer selected from the group consisting of the polymer layer P, the inner polymer layer, the outer polymer layer, and the polymer interlayer, or a combination of at least two of these, particularly preferred by the polymer layer P. Layers covering the hole are referred to herein as hole-covering layers. If at least 2 hole-covering layers are present, the hole-covering layers in the hole preferably form a layer sequence of layers joined to one another in the hole.

In one embodiment 22 of the invention, the sheetlike composite 1 is configured according to any of its preceding embodiments, wherein one selected from the group consisting of the inner polymer layer, the polymer interlayer and the outer polymer layer, or a combination of at least two of these, comprises, preferably consists of, a polyethylene or a polypropylene or a mixture of the two.

In one embodiment 23 of the invention, the sheetlike composite 1 is configured according to any of its preceding embodiments, wherein the carrier layer comprises, preferably consists of, one selected from the group consisting of cardboard, paperboard and paper, or a combination of at least two of these. The carrier layer preferably has a basis weight within a range of 140 to 400 g/m², preferably of 150 to 350 g/m², more preferably of 160 to 330 g/m², even more preferably of 160 to 300 g/m², even more preferably of 160 to 250 g/m², most preferably of 160 to 240 g/m².

In one embodiment 24 of the invention, the sheetlike composite 1 is configured according to any of its preceding embodiments, wherein the barrier layer comprises, preferably consists of, one selected from the group consisting of a plastic, a metal and a metal oxide, or a combination of at least two of these.

In one embodiment 25 of the invention, the sheetlike composite 1 is configured according to any of its preceding embodiments, wherein the polymer layer P has a first shear viscosity at a first shear frequency of 0.1 rad/s and a further shear viscosity at a further shear frequency of 100 rad/s, where a ratio of the first shear viscosity to the further shear viscosity is at least 3, preferably at least 4, more preferably at least 5, more preferably at least 6, more preferably at least 6.5, more preferably at least 7, more preferably at least 8, more preferably at least 9, more preferably at least 10, even more preferably at least 11, most preferably at least 12. The aforementioned ratio is preferably not more than 30, more preferably not more than 20. The first and further shear viscosities are each determined by the method specified herein. The first shear viscosity and further shear viscosity herein are values for the physical parameter of shear viscosity, which is a function of the physical parameter of shear frequency. In addition, the first shear frequency and further shear frequency are values of the physical parameter of shear frequency, which is a parameter of the physical quantity of shear viscosity.

In one embodiment 26 of the invention, the sheetlike composite 1 is configured according to its embodiment 25, wherein the further shear viscosity is less than the first shear viscosity by 100 to 10 000 Pa·s, more preferably by 100 to 9000 Pa·s, more preferably by 100 to 8000 Pa·s, more preferably by 500 to 8000 Pa·s, more preferably by 1000 to 8000 Pa·s, more preferably by 1200 to 8000 Pa·s, even more preferably by 1500 to 7800 Pa·s, most preferably by 1500 to 7600 Pa·s. In a further preferred embodiment, the further shear viscosity is less than the first shear viscosity by 1000 to 2000 Pa·s, preferably by 1200 to 1800 Pa·s, more preferably by 1400 to 1600 Pa·s. In a further preferred embodiment, the further shear viscosity is less than the first shear viscosity by 6500 to 8300 Pa·s, preferably by 6800 to 8000 Pa·s, more preferably by 7000 to 7600 Pa·s.

In one embodiment 27 of the invention, the sheetlike composite 1 is configured according to its embodiment 25 or 26, wherein a dependence of a shear viscosity of the polymer layer P on a shear frequency in the range from the first shear frequency to the further shear frequency is described by a monotonously decreasing function, preferably by a strictly monotonously decreasing function. The shear viscosity here is determined by the method described herein.

In one embodiment 28 of the invention, the sheetlike composite 1 is configured according to any of its preceding embodiments, wherein the polymer layer P shows a nonlinear dependence of its shear viscosity on a shear frequency. The shear viscosity is determined by the method described herein. The dependence of the shear viscosity on the shear frequency is nonlinear here when a slope of the shear viscosity against the shear frequency is not constant. An absolute magnitude of the slope of the shear viscosity against the shear frequency preferably decreases here with increasing shear frequency. Further preferably, the slope of the shear viscosity against the shear frequency is negative, which means that this slope preferably increases with increasing shear frequency. The shear viscosity preferably shows the nonlinear dependence on the shear frequency at least within a range from the first shear frequency up to the further shear frequency.

In one embodiment 29 of the invention, the sheetlike composite 1 is configured according to any of its embodiments 25 to 28, wherein a shear viscosity of the polymer layer P is a function of a shear frequency, wherein the function has a first slope at the first shear frequency and a further slope at the further shear frequency, the further slope being different from the first slope. An absolute magnitude of the further slope is preferably less than an absolute magnitude of the first slope. Further preferably, the first slope and the further slope are negative. Accordingly, the further slope is preferably greater than the first slope. The shear viscosity here is determined by the method specified herein. An absolute magnitude of the further slope preferably differs from an absolute magnitude of the first slope, and is more preferably less than the absolute magnitude of the first slope, by at least 200 Pa·s²/rad, more preferably by at least 300 Pa·s²/rad, more preferably by at least 400 Pa·s²/rad, more preferably by at least 500 Pa·s²/rad, more preferably by at least 1000 Pa·s²/rad, more preferably by at least 2000 Pa·s²/rad, more preferably by at least 3000 Pa·s²/rad, more preferably by at least 4000 Pa·s²/rad, more preferably by at least 5000 Pa·s²/rad, more preferably by at least 6000 Pa·s²/rad, even more preferably by at least 7000 Pa·s²/rad, most preferably by at least 7500 Pa·s²/rad. The first shear frequency and further shear frequency here are values of the physical parameter of shear frequency, which is a parameter of the function that describes the dependence of the shear viscosity on the shear frequency.

In one embodiment 30 of the invention, the sheetlike composite 1 is configured according to any of its preceding embodiments, wherein the polymer layer P has a density of more than 1.1 g/cm³, preferably of more than 1.15 g/cm³, more preferably of at least 1.2 g/cm³. Particularly preferred, the density of the polymer layer P is within a range from 1.2 to 2 g/cm³, more preferably from 1.2 to 1.5 g/cm³, most preferably from 1.2 to 1.4 g/cm³.

A contribution to the achievement of at least one of the objects of the invention is made by an embodiment 1 of a method 1 comprising, as method steps,
a) providing
   i) a sheetlike composite precursor comprising a carrier layer, and
   ii) a polymer composition P comprising a polyester; and
b) superimposing the carrier layer with the polymer composition P, thereby obtaining a polymer layer P superimposing the carrier layer;
   wherein the polymer layer P
a. extends two-dimensionally within a layer plane,
b. has a first modulus of elasticity in a first layer direction which lies in the layer plane, and
c. has a further modulus of elasticity in a further layer direction which lies in the layer plane and is perpendicular to the first layer direction,
   wherein a ratio of the first modulus of elasticity to the further modulus of elasticity is within a range from 0.81 to 1.19, preferably from 0.82 to 1.18, more preferably from 0.83 to 1.17, more preferably from 0.84 to 1.16, more preferably from 0.85 to 1.15, more preferably from 0.86 to 1.14, more preferably from 0.87 to 1.17, more preferably from 0.88 to 1.12, more preferably from 0.89 to 1.11, more preferably from 0.9 to 1.1, more preferably from 0.91 to 1.09, more preferably from 0.92 to 1.08, more preferably from 0.93 to 1.07, more preferably from 0.94 to 1.06, even more preferably from 0.95 to 1.05, most preferably from 0.96 to 1.04. The polymer layer P is preferably obtained from the polymer composition P, preferably by means of cooling and solidification of the polymer composition P. The carrier layer is preferably configured according to any embodiment of the sheetlike composite 1 of the invention. The first and further modulus of elasticity are determined by the method specified herein. The carrier layer is preferably configured according to any embodiment of the sheetlike composite 1 of the invention.

In one embodiment 2 of the invention, the method 1 is configured according to its embodiment 1, wherein the polymer composition P is liquid in the superimposing operation in method step b). The polymer composition P in the superimposing operation in method step b) preferably has a temperature above its melting temperature. The polymer composition P is preferably molten in the superimposing operation in method step b). Particularly preferred, the superimposing in method step b) is effected as a melt coating operation. A preferred form of melt coating is melt extrusion coating.

A contribution to the achievement of at least one of the objects of the invention is made by an embodiment 1 of a method 2 comprising, as method steps,
a) providing
   i) a sheetlike composite precursor comprising a carrier layer, and
   ii) a polymer composition P comprising a polyester; and
b) superimposing the carrier layer with the polymer composition P, thereby obtaining a polymer layer P superimposing the carrier layer;
   wherein the polymer composition P is liquid in the superimposing operation in method step b). The polymer composition P in the superimposing operation in method step b) preferably has a temperature above its melting temperature. The polymer composition P is preferably molten in the superimposing operation in method step b). More preferably, the superimposing operation in method step b) is effected as a melt coating operation. A preferred form of melt coating is melt extrusion coating. The polymer layer P is preferably obtained from the polymer composition P, preferably by means of cooling and solidification of the polymer composition P. The carrier layer is preferably configured according to any embodiment of the sheetlike composite 1 of the invention.

In one embodiment 2 of the invention, the method 2 is configured according to its embodiment 1, wherein the polymer layer P extends two-dimensionally in a layer plane, wherein the polymer layer P has
a] a first modulus of elasticity which lies in the layer plane, and
b] a further modulus of elasticity in a further layer direction which lies in the layer plane and is perpendicular to the first layer direction,
   wherein a ratio of the first modulus of elasticity to the further modulus of elasticity is within a range from 0.81 to 1.19, preferably from 0.82 to 1.18, more preferably from 0.83 to 1.17, more preferably from 0.84 to 1.16, more preferably from 0.85 to 1.15, more preferably from 0.86 to 1.14, more preferably from 0.87 to 1.17, more preferably from 0.88 to 1.12, more preferably from 0.89 to 1.11, more preferably from 0.9 to 1.1, more preferably from 0.91 to 1.09, more preferably from 0.92 to 1.08, more preferably from 0.93 to 1.07, more preferably from 0.94 to 1.06, even more preferably from 0.95 to 1.05, most preferably from 0.96 to 1.04. The first and further modulus of elasticity are each determined by the method specified herein.

In one embodiment 3 of the invention, method 1 or 2 is respectively configured according to its embodiment 1 or 2, wherein the superimposing operation in method step b) in each case comprises a melt extrusion coating operation with the polymer composition P.

In one inventive embodiment 4 of method 1, this is configured according to any of its embodiments 1 to 3, and, in one inventive embodiment 4 of method 2, this is configured according to either of its embodiments 2 and 3, wherein the first modulus of elasticity in each case is within a range from 100 to 3000 MPa, preferably from 120 to 2500 MPa, more preferably from 140 to 2200 MPa.

In one embodiment 5 of the invention, method 1 is respectively configured according to any of its embodiments 1 to 4 and method 2 according to any of its embodiments 2 to 4, wherein the further modulus of elasticity in each case is within a range from 100 to 3000 MPa, preferably from 140 to 2600 MPa, more preferably from 150 to 2250 MPa.

In one embodiment 6 of the invention, method 1 or 2 is respectively configured according to any of its embodiments preceding embodiments, wherein the providing of the polymer composition P in method step a) comprises
A) providing a base polymer and a chain modifier, and
B) reacting the base polymer with the chain modifier, thereby obtaining the polyester.

The reacting of the base polymer with the chain modifier preferably comprises a chain extension reaction.

In one embodiment 7 of the invention, method 1 or 2 is respectively configured according to its embodiment 6, wherein, in method step B), the base polymer and the chain modifier are contacted with one another in a weight ratio of chain modifier to base polymer within a range from 0.0001 to 0.1, preferably from 0.0002 to 0.07, more preferably from 0.0005 to 0.05, even more preferably from 0.0007 to 0.03, most preferably from 0.001 to 0.01.

In one embodiment 8 of the invention, method 1 and method 2 are respectively configured according to their embodiment 6 or 7, wherein the base polymer is obtainable from a renewable raw material. The base polymer is preferably obtainable from the renewable raw material by means of a method comprising a monomer formation or a polymerization reaction or both, with preferably at least the monomer formation being effected in a fermentation.

In one embodiment 9 of the invention, method 1 and method 2 are respectively configured according to any of their embodiments 6 to 8, wherein the base polymer is reacted with the chain modifier at least partly in an extruder.

In one embodiment 10 of the invention, method 1 and method 2 are respectively configured according to any of their preceding embodiments, wherein the sheetlike composite precursor is provided in method step a) in rolled-up form as a roll.

In one embodiment 11 of the invention, method 1 and method 2 are respectively configured according to any of their embodiments 1 to 10, wherein a carbon content of the polymer composition P is biobased to an extent of at least 25%, more preferably to an extent of at least 30%, more preferably to an extent of at least 40%, more preferably to an extent of at least 50%, more preferably to an extent of at least 60%, more preferably to an extent of at least 70%, even more preferably to an extent of at least 80%, most preferably to an extent of at least 90%. The biobased carbon content of the polymer layer P is determined by the method specified herein.

In one embodiment 12 of the invention, method 1 and method 2 are respectively configured according to any of their embodiments 1 to 11, wherein the polymer composition P comprises the polyester in a proportion within a range from 5% to 100% by weight, preferably from 10% to 100% by weight, more preferably from 20% to 100% by weight, more preferably from 30% to 100% by weight, more preferably from 40% to 100% by weight, more preferably from 50% to 100% by weight, more preferably from 55% to 100% by weight, more preferably from 60% to 100% by weight, more preferably from 65% to 100% by weight, more preferably from 70% to 100% by weight, more preferably from 75% to 100% by weight, more preferably from 80% to 100% by weight, more preferably from 85% to 100% by weight, more preferably from 90% to 100% by weight, more preferably from 92% to 100% by weight, more preferably from 94% to 100% by weight, even more preferably from 96% to 100% by weight, most preferably from 98% to 100% by weight, based in each case on the weight of the polymer composition P.

In one embodiment 13 of the invention, method 1 and method 2 are respectively configured according to any of their embodiments 1 to 12, wherein the polyester is a homopolymer.

In one embodiment 14 of the invention, method 1 and method 2 are respectively configured according to any of their embodiments 1 to 13, wherein the polyester is a thermoplastic polymer.

In one embodiment 15 of the invention, method 1 and method 2 are respectively configured according to any of their embodiments 1 to 14, wherein the polymer composition P has a melting temperature of more than 145° C., preferably of more than 146° C., more preferably of more than 147° C., more preferably of more than 148° C., more preferably of more than 149° C., more preferably of more than 150° C., more preferably of more than 155° C., more preferably of more than 158° C., more preferably of more than 160° C., more preferably of more than 161° C., more preferably of more than 162° C., preferably of more than 163° C., more preferably of more than 164° C., more preferably of more than 165° C., more preferably of more than 166° C., more preferably of more than 167° C., more preferably of more than 168° C., more preferably of more than 169° C., more preferably of more than 170° C., more preferably more than 175° C., more preferably of more than 180° C., more preferably of more than 190° C., more preferably of more than 200° C., more preferably of more than 210° C., more preferably of more than 220° C., more preferably of more than 230° C., even more preferably of more than 235° C., most preferably of more than 238° C. The melting temperature is determined by the test method specified herein. The aforementioned melting temperature of the polymer composition P is preferably not more than 500° C., more preferably not more than 450° C., even more preferably not more than 400° C., even more preferably not more than 350° C., most preferably not more than 300° C. The polyester preferably has the abovementioned melting temperature of the polymer composition P.

In one embodiment 16 of the invention, method 1 and method 2 are respectively configured according to any of their embodiments 1 to 15, wherein the polyester is selected from the group consisting of a polylactide (PLA), a polyhydroxyalkanoate, and a polyalkylene terephthalate, or from a combination of at least two of these. A preferred polyhydroxyalkanoate (PHA) is a polyhydroxybutyrate (PHB). A preferred polyhydroxybutyrate is poly-(R)-3-hydroxybutyrate (P(3HB)). A preferred polyalkylene terephthalate is polybutylene terephthalate or polyethylene terephthalate (PET), particular preference being given to PET. A preferred PET is a recycled PET or a bio-PET or both. Bio-PET refers in this connection to a PET having a carbon content which is biobased to an extent of at least 25%, more preferably to an extent of at least 30%.

In one embodiment 17 of the invention, method 1 and method 2 are respectively configured according to any of their embodiments 1 to 16, wherein the polymer composition P has an intrinsic viscosity within a range from 0.5 to 1.0 dl/g, preferably from 0.6 to 1.0 dl/g, more preferably from 0.7 to 1.0 dl/g. The intrinsic viscosity of the polymer composition P is determined by the method described herein.

In one embodiment 18 of the invention, method 1 and method 2 are respectively configured according to any of their embodiments 1 to 17, wherein the polymer composition P is characterized by a melt flow rate (MFR) within a range from 2 to 15 g/10 min, preferably from 3 to 15 g/10 min, more preferably from 4 to 15 g/10 min, most preferably from 5 to 15 g/10 min.

In one embodiment 19, method 1 and method 2 are respectively configured according to any of their embodiments 1 to 18, wherein the polymer composition P is applied directly to the carrier layer in method step b). Consequently, the polymer layer P adjoins the carrier layer.

In one embodiment 20 of the invention, method 1 and method 2 are respectively configured according to any of their embodiments 3 to 20, wherein the polymer composition P in method step b) has a neck-in within a range from 10 to 25, preferably from 12 to 23, more preferably from 14 to 21, even more preferably from 16 to 19, most preferably from 17 to 18. The neck-in is determined by the method specified herein.

In one embodiment 21 of the invention, method 1 and method 2 are respectively configured according to any of their embodiments 1 to 20, wherein the method further comprises superimposing the carrier layer with a barrier layer. The barrier layer is preferably configured according to any embodiment of the sheetlike composite 1 of the invention. The superimposing with the barrier layer is preferably effected in such a way that the polymer layer P adjoins the barrier layer.

In one embodiment 22 of the invention, method 1 and method 2 are respectively configured according to their embodiment 21, wherein the superimposing of the carrier layer with the barrier layer precedes the superimposing of the carrier layer with the polymer composition P in method step b). In this embodiment, the polymer layer P obtained from the polymer composition P is preferably an inner polymer layer. The inner polymer layer is preferably configured, or arranged, or both, according to any embodiment of the sheetlike composite 1 of the invention.

In one embodiment 23 of the invention, method 1 and method 2 are respectively configured according to their embodiment 21, wherein the carrier layer is superimposed with the barrier layer in a method step c). The superimposing with the barrier layer in method step c) preferably does not precede the superimposing with the polymer composition P in method step b). Further preferably, the superimposing with the barrier layer in method step c) is effected subsequently to the superimposing with the polymer composition P in method step b), is simultaneous with method step b) or overlaps in time with method step b). In the latter case, the superimposing with the polymer composition P preferably starts prior to the superimposing with the barrier layer. In this embodiment, the polymer layer P obtained from the polymer composition P is preferably a polymer interlayer or an outer polymer layer. The outer polymer layer and the polymer interlayer are preferably each configured, or arranged, or both, according to any embodiment of the sheetlike composite 1 of the invention.

In one embodiment 24 of the invention, method 1 and method 2 are respectively configured according to any of their embodiments 21 to 23, wherein the superimposing of the carrier layer with the polymer composition P in method step b) is effected on the same side of the carrier layer as the superimposing of the carrier layer with the barrier layer. In this embodiment, the polymer layer P obtained from the polymer composition P is preferably a polymer interlayer or an inner polymer layer. The polymer interlayer and the inner polymer layer are preferably each configured, or arranged, or both, according to any embodiment of the sheetlike composite 1 of the invention.

In one embodiment 25 of the invention, method 1 and method 2 are respectively configured according to any of their embodiments 21 to 23, wherein the superimposing of the carrier layer with the polymer composition P in method step b) is effected on a first side of the carrier layer, wherein the superimposing of the carrier layer with the barrier layer is effected on an opposite side of the carrier layer from the first side. In this embodiment, the polymer layer P obtained from the polymer composition P is preferably an outer polymer layer. The outer polymer layer is preferably configured, or arranged, or both, according to any embodiment of the sheetlike composite 1 of the invention.

In one embodiment 26 of the invention, method 1 and method 2 are respectively configured according to any of their embodiments 1 to 25, wherein method step b) is preceded by creation of at least one hole in the carrier layer, wherein the hole is covered at least with the polymer layer P in method step b). The hole is preferably additionally or alternatively covered with the barrier layer when the carrier layer is covered with the barrier layer.

In one embodiment 27 of the invention, method 1 and method 2 are respectively configured according to any of their embodiments 21 to 26, wherein the method further comprises superimposing the barrier layer with an inner polymer layer on a side of the barrier layer remote from the carrier layer. The inner polymer layer is preferably configured according to any embodiment of the sheetlike composite 1 of the invention.

In one embodiment 28 of the invention, method 1 and method 2 are respectively configured according to any of their embodiments 21 to 27, wherein a polymer interlayer is disposed between the carrier layer and the barrier layer when the carrier layer is superimposed with the barrier layer. The polymer interlayer is preferably configured according to any embodiment of the sheetlike composite 1 of the invention.

In one embodiment 29 of the invention, method 1 and method 2 are respectively configured according to any of their embodiments 1 to 28, wherein the method additionally comprises superimposing the carrier layer with an ink application. In a preferred embodiment, the superimposing of the carrier layer with the ink application is effected subsequently to the superimposing of the carrier layer with the outer polymer layer, on the same side of the carrier layer. In a further preferred embodiment, the superimposing of the carrier layer with the ink application precedes the superimposing of the carrier layer with the outer polymer layer, on the same side of the carrier layer.

In one embodiment 30 of the invention, method 1 and method 2 are respectively configured according to their embodiment 29, wherein the carrier layer is superimposed with the ink application prior to method step b).

In one embodiment 31 of the invention, method 1 and method 2 are respectively configured according to their embodiment 29, wherein the carrier layer is superimposed with the ink application after method step b).

In one embodiment 32 of the invention, method 1 and method 2 are respectively configured according to one of their embodiments 29 to 31, wherein the superimposing of the carrier layer with the ink application and the superimposing of the carrier layer with the polymer composition P in method step b) are effected on the same side of the carrier layer.

In one embodiment 33 of the invention, method 1 and method 2 are respectively configured according to one of their embodiments 1 to 32, wherein a sheetlike composite is obtained from the sheetlike composite precursor, wherein the method additionally comprises cutting the sheetlike composite to size to give a blank for production of a single, preferably closed, container.

In one embodiment 34 of the invention, method 1 and method 2 are each configured according to any of their embodiments 1 to 33, wherein the method is a method of producing a sheetlike composite, preferably the sheetlike composite 1 of the invention according to any of its embodiments.

In one embodiment 35 of the invention, method 1 and method 2 are each configured according to any of their embodiments 1 to 34, wherein the polymer composition P has a first shear viscosity at a first shear frequency of 0.1 rad/s and a further shear viscosity at a further shear frequency of 100 rad/s, where a ratio of the first shear viscosity to the further shear viscosity is at least 3, preferably at least 4, more preferably at least 5, more preferably at least 6, more preferably at least 6.5, more preferably at least 7, more preferably at least 8, more preferably at least 9, more preferably at least 10, even more preferably at least 11, most preferably at least 12. The aforementioned ratio is preferably not more than 30, more preferably not more than 20. The first and further shear viscosity are each determined by the method specified herein. The first shear viscosity and further shear viscosity herein are values for the physical parameter of shear viscosity, which is a function of the physical parameter of shear frequency. In addition, the first shear frequency and further shear frequency are values of the physical parameter of shear frequency, which is a parameter of the physical quantity of shear viscosity.

In one embodiment 36 of the invention, method 1 and method 2 are respectively configured according to their embodiment 35, wherein the further shear viscosity is less than the first shear viscosity by 100 to 10 000 Pa·s, more preferably by 100 to 9000 Pa·s, more preferably by 100 to 8000 Pa·s, more preferably by 500 to 8000 Pa·s, more preferably by 1000 to 8000 Pa·s, more preferably by 1200 to 8000 Pa·s, even more preferably by 1500 to 7800 Pa·s, most preferably by 1500 to 7600 Pa·s. In a further preferred embodiment, the further shear viscosity is less than the first shear viscosity by 1000 to 2000 Pa·s, preferably by 1200 to 1800 Pa·s, more preferably by 1400 to 1600 Pa·s. In a further preferred embodiment, the further shear viscosity is less than the first shear viscosity by 6500 to 8300 Pa·s, preferably by 6800 to 8000 Pa·s, more preferably by 7000 to 7600 Pa·s.

In one embodiment 37 of the invention, method 1 and method 2 are respectively configured according to their embodiment 35 or 36, wherein a dependence of a shear viscosity of the polymer composition P on a shear frequency in the range from the first shear frequency to the further shear frequency is described by a monotonously decreasing function, preferably by a strictly monotonously decreasing function. The shear viscosity here is determined by the method described herein.

In one embodiment 38 of the invention, method 1 and method 2 are respectively configured according to any of their preceding embodiments, wherein the polymer composition P shows a nonlinear dependence of its shear viscosity on a shear frequency. The shear viscosity is determined by the method described herein. The dependence of the shear viscosity on the shear frequency is nonlinear here when a slope of the shear viscosity against the shear frequency is not constant. An absolute magnitude of the slope of the shear viscosity against the shear frequency preferably decreases here with increasing shear frequency. Further preferably, the slope of the shear viscosity against the shear frequency is negative, which means that this slope preferably increases with increasing shear frequency. The shear viscosity preferably shows the nonlinear dependence on the shear frequency at least within a range from the first shear frequency up to the further shear frequency.

In one embodiment 39 of the invention, method 1 and method 2 are respectively configured according to any of their embodiments 35 to 38, wherein a shear viscosity of the polymer composition P is a function of a shear frequency, wherein the function has a first slope at the first shear frequency and a further slope at the further shear frequency, the further slope being different from the first slope. An absolute magnitude of the further slope is preferably less than an absolute magnitude of the first slope. Further preferably, the first slope and the further slope are negative.

Accordingly, the further slope is preferably greater than the first slope. The shear viscosity here is determined by the method specified herein. An absolute magnitude of the further slope preferably differs from an absolute magnitude of the first slope, and is more preferably less than the absolute magnitude of the first slope, by at least 200 Pa·s²/rad, more preferably by at least 300 Pa·s²/rad, more preferably by at least 400 Pa·s²/rad, more preferably by at least 500 Pa·s²/rad, more preferably by at least 1000 Pa·s²/rad, more preferably by at least 2000 Pa·s²/rad, more preferably by at least 3000 Pa·s²/rad, more preferably by at least 4000 Pa·s²/rad, more preferably by at least 5000 Pa·s²/rad, more preferably by at least 6000 Pa·s²/rad, even more preferably by at least 7000 Pa·s²/rad, most preferably by at least 7500 Pa·s²/rad. The first shear frequency and the further shear frequency here are values of the physical parameter of shear frequency, which is a parameter of the function that describes the dependence of the shear viscosity on the shear frequency.

In one embodiment 40 of the invention, method 1 and method 2 are respectively configured according to any of their embodiments 1 to 39, wherein the polymer composition P has a density of more than 1.1 g/cm³, preferably of more than 1.15 g/cm³, more preferably of at least 1.2 g/cm³. Particularly preferred the density of the polymer composition P is within a range from 1.2 to 2 g/cm³, more preferably from 1.2 to 1.5 g/cm³, most preferably from 1.2 to 1.4 g/cm³. Further preferably, the polymer layer P obtained from the polymer composition P has the above density.

A contribution to the achievement of at least one of the objects of the invention is made by an embodiment 1 of a sheetlike composite 2 obtainable by method 1 or 2 in each case according to any of its embodiments 1 to 40. The sheetlike composite 2 preferably has one or more features of the sheetlike composite 1 in any of its embodiments.

A contribution to the achievement of at least one of the objects of the invention is made by an embodiment 1 of a container precursor 1 comprising at least one sheetlike region of the sheetlike composite 1 or 2, in each case according to any of its embodiments. The container precursor preferably comprises a blank of the sheetlike composite for production of a single container.

In one embodiment 2 of the invention, the container precursor 1 is configured according to its embodiment 1, wherein the sheetlike region comprises at least two folds, preferably at least 3 folds, more preferably at least 4 folds.

In one embodiment 3 of the invention, the container precursor 1 is configured according to its embodiment 1 or 2, wherein the sheetlike region comprises a first longitudinal rim and a further longitudinal rim, wherein the first longitudinal rim is joined to the further longitudinal rim, thereby forming a longitudinal seam of the container precursor.

A contribution to the achievement of at least one of the objects of the invention is made by an embodiment 1 of a container 1 comprising at least one sheetlike region of the sheetlike composite 1 or 2, in each case according to any of its embodiments. The container of the invention is preferably a closed container. The container preferably comprises a blank of the sheetlike composite for production of a single container.

In one embodiment 2 of the invention, the container 1 is configured according to its embodiment 1, wherein the sheetlike region comprises at least two folds, preferably at least 3 folds, more preferably at least 4 folds.

In one embodiment 3 of the invention, the container 1 is configured according to its embodiment 1 or 2, wherein the sheetlike region comprises a first longitudinal rim and a further longitudinal rim, wherein the first longitudinal rim is joined to the further longitudinal rim, thereby forming a longitudinal seam of the container.

In one embodiment 4 of the invention, the container 1 is configured according to any of its embodiments 1 to 3, wherein the container comprises a food or drink product.

A contribution to the achievement of at least one of the objects of the invention is made by an embodiment 1 of a method 3 including, as method steps,
a. providing at least one sheetlike region of the sheetlike composite 1 or 2, in each case according to one of its embodiments, said at least one sheetlike region comprising a first longitudinal rim and a further longitudinal rim;
b. folding the at least one sheetlike region; and
c. contacting and joining the first longitudinal rim to the further longitudinal rim, thereby obtaining a longitudinal seam.

The method 3 is preferably a method of producing a container precursor. A preferred container precursor is a precursor of a food or drink product container. The joining in method step c. is preferably effected in the form of sealing.

A contribution to the achievement of at least one of the objects of the invention is made by an embodiment 1 of a container precursor 2, obtainable by the method 3 according to its embodiment 1.

A contribution to the achievement of at least one of the objects of the invention is made by an embodiment 1 of a method 4 comprising, as method steps,
A. providing the container precursor 1 or 2, in each case according to any of its embodiments;
B. forming a base region of the container precursor by folding the sheetlike region;
C. closing the base region;
D. filling the container precursor with a food or drink product; and
E. closing the container precursor in a top region, thereby obtaining a closed container.

Method 4 is preferably a method of producing the closed container. A preferred closed container is a food or drink product container. The closing in method step C) preferably comprises sealing, more preferably hot air sealing. The closing in method step E) preferably comprises sealing, more preferably ultrasound sealing.

In one embodiment 2 of the invention, the method 4 is configured according to its embodiment 1, wherein at least a part of the sheetlike region during the folding in method step B. has a temperature within a range from 10 to 50° C., preferably from 15 to 40° C., more preferably from 16 to 30° C., most preferably from 18 to 25° C.

In one embodiment 3 of the invention, the method 4 is configured according to its embodiment 1 or 2, wherein the closing in method step C. or E. or in both comprises sealing, wherein the sealing is effected by one selected from the group consisting of irradiation, contacting with a hot solid, inducement of a mechanical vibration, and contacting with a hot gas, or by a combination of at least two of these. In this case, a different sealing method from the aforementioned group may be used in method step C. from that in method step E. and vice versa. However, it is also possible to use the same sealing method.

In one embodiment 4 of the invention, the method 4 is configured according to any of its embodiments 1 to 3, wherein the method further comprises a method step of
F. joining the closed container to an opening aid.

A contribution to the achievement of at least one of the objects of the invention is made by an embodiment 1 of a closed container 2 obtainable by the method 4 according to any of its embodiments 1 to 4.

A contribution to the achievement of at least one of the objects of the invention is made by an embodiment 1 of a use 1 of the sheetlike composite 1 or 2, in each case according to any of its embodiments, for production of a food or drink product container. A preferred food or drink product container is a closed container filled with a food or drink product.

A contribution to the achievement of at least one of the objects of the invention is made by an embodiment 1 of a use 2 of an extruder for reacting of a base polymer with a chain modifier, thereby obtaining a polymer P, and for obtaining a sheetlike composite for a food or drink product container by means of melt extrusion coating with the polymer P. For the reaction, the base polymer and the chain modifier are contacted with one another preferably in a weight ratio of chain modifier to base polymer within a range from 0.0001 to 0.1, preferably from 0.0002 to 0.07, more preferably from 0.0005 to 0.05, even more preferably from 0.0007 to 0.03, most preferably from 0.001 to 0.01. The reacting of the base polymer with the chain modifier preferably comprises a chain extension reaction. The polymer P is preferably a polyester.

The sheetlike composite preferably comprises, as mutually superposed layers in a direction from an outer face of the sheetlike composite to an inner face of the sheetlike composite,
a) a carrier layer, and
b) a barrier layer,
   wherein the sheetlike composite additionally comprises a polymer layer P, wherein the polymer layer P comprises the polymer P. The sheetlike composite is preferably configured according to any embodiment of the sheetlike composite 1 of the invention. The polymer P is preferably the polyester according to any embodiment of the sheetlike composite 1 of the invention. Alternatively or additionally, the base polymer is the base polymer according to any embodiment of the sheetlike composite 1 of the invention. Alternatively or additionally, the polymer layer P preferably has one or more features of the polymer layer P according to any embodiment of the sheetlike composite 1 of the invention. In particular, a carbon content of the base polymer is preferably biobased to an extent of at least 25%, more preferably to an extent of at least 30%, more preferably to an extent of at least 40%, more preferably to an extent of at least 50%, more preferably to an extent of at least 60%, more preferably to an extent of at least 70%, even more preferably to an extent of at least 80%, most preferably to an extent of at least 90%.

A contribution to the achievement of at least one of the objects of the invention is made by an embodiment 1 of a use 3 of a chain modifier for production of a sheetlike composite for a food or drink product container. The sheetlike composite preferably comprises, as mutually superposed layers in a direction from an outer face of the sheetlike composite to an inner face of the sheetlike composite,
a) a carrier layer, and
b) a barrier layer,
   wherein the sheetlike composite additionally comprises a polymer layer P, wherein the polymer layer P comprises a polymer P, wherein the polymer P is obtainable by reacting a base polymer with the chain modifier. The polymer P is preferably a polyester. For the reaction, the base polymer and the chain modifier are contacted with one another preferably in a weight ratio of chain modifier to base polymer within a range from 0.0001 to 0.1, preferably from 0.0002 to 0.07, more preferably from 0.0005 to 0.05, even more preferably from 0.0007 to 0.03, most preferably from 0.001 to 0.01. The reacting of the base polymer with the chain modifier preferably comprises a chain extension reaction. The sheetlike composite is preferably configured according to any embodiment of the sheetlike composite 1 of the invention. The polymer P is preferably the polyester according to any embodiment of the sheetlike composite 1 of the invention. Alternatively or additionally, the base polymer is the base polymer according to any embodiment of the sheetlike composite 1 of the invention. Alternatively or additionally, the polymer layer P preferably has one or more features of the polymer layer P according to any embodiment of the sheetlike composite 1 of the invention. In particular, a carbon content of the base polymer is preferably biobased to an extent of at least 25%, more preferably to an extent of at least 30%, more preferably to an extent of at least 40%, more preferably to an extent of at least 50%, more preferably to an extent of at least 60%, more preferably to an extent of at least 70%, even more preferably to an extent of at least 80%, most preferably to an extent of at least 90%.

A contribution to the achievement of at least one of the objects of the invention is made by an embodiment 1 of a use 4 of a mixture comprising a base polymer and a chain modifier for production of a sheetlike composite for a food or drink product container. The mixture comprises the base polymer and the chain modifier preferably in a weight ratio of chain modifier to base polymer within a range from 0.0001 to 0.1, preferably from 0.0002 to 0.07, more preferably from 0.0005 to 0.05, even more preferably from 0.0007 to 0.03, most preferably from 0.001 to 0.01. The sheetlike composite preferably comprises, as mutually superposed layers in a direction from an outer face of the sheetlike composite to an inner face of the sheetlike composite,
a) a carrier layer, and
b) a barrier layer,
   wherein the sheetlike composite additionally comprises a polymer layer P, wherein the polymer layer P comprises a polymer P, wherein the polymer P is obtainable by reacting the base polymer with the chain modifier. The polymer P is preferably a polyester. The reacting of the base polymer with the chain modifier preferably comprises a chain extension reaction. The sheetlike composite is preferably configured according to any embodiment of the sheetlike composite 1 of the invention. The polymer P is preferably the polyester according to any embodiment of the sheetlike composite 1 of the invention. Alternatively or additionally, the base polymer is the base polymer according to any embodiment of the sheetlike composite 1 of the invention. Alternatively or additionally, the polymer layer P preferably has one or more features of the polymer layer P according to any embodiment of the sheetlike composite 1 of the invention. In particular, a carbon content of the base polymer is preferably biobased to an extent of at least 25%, more preferably to an extent of at least 30%, more preferably to an extent of at least 40%, more preferably to an extent of at least 50%, more preferably to an extent of at least 60%, more preferably to an extent of at least 70%, even more preferably to an extent of at least 80%, most preferably to an extent of at least 90%.

A contribution to the achievement of at least one of the objects of the invention is made by an embodiment 1 of a use 5 of a base polymer for production of a sheetlike composite for a food or drink product container by means of reacting the base polymer with a chain modifier. For the reaction, the base polymer and the chain modifier are contacted with one another preferably in a weight ratio of chain modifier to base polymer within a range from 0.0001 to 0.1, preferably from 0.0002 to 0.07, more preferably from 0.0005 to 0.05, even more preferably from 0.0007 to 0.03, most preferably from 0.001 to 0.01. The reacting of the base polymer with the chain modifier preferably comprises a chain extension reaction. The sheetlike composite preferably comprises, as mutually superposed layers in a direction from an outer face of the sheetlike composite to an inner face of the sheetlike composite,
a) a carrier layer, and
b) a barrier layer,
   wherein the sheetlike composite additionally comprises a polymer layer P, wherein the polymer layer P comprises a polymer P, wherein the polymer P is obtainable by the reacting of the base polymer with the chain modifier. The polymer P is preferably a polyester. The sheetlike composite is preferably configured according to any embodiment of the sheetlike composite 1 of the invention. The polymer P is preferably the polyester according to any embodiment of the sheetlike composite 1 of the invention. Alternatively or additionally, the base polymer is preferably the base polymer according to any embodiment of the sheetlike composite 1 of the invention. Alternatively or additionally, the polymer layer P preferably has one or more features of the polymer layer P according to any embodiment of the sheetlike composite 1 of the invention. In particular, a carbon content of the base polymer is preferably biobased to an extent of at least 25%, more preferably to an extent of at least 30%, more preferably to an extent of at least 40%, more preferably to an extent of at least 50%, more preferably to an extent of at least 60%, more preferably to an extent of at least 70%, even more preferably to an extent of at least 80%, most preferably to an extent of at least 90%.

A contribution to the achievement of at least one of the objects of the invention is made by an embodiment 1 of a use 6 of a polyester for production of a sheetlike composite for a food or drink product container by means of melt extrusion coating with the polyester.

The sheetlike composite preferably comprises, as mutually superposed layers in a direction from an outer face of the sheetlike composite to an inner face of the sheetlike composite,
a) a carrier layer, and
b) a barrier layer,
   wherein the sheetlike composite additionally comprises a polymer layer P, wherein the polymer layer P comprises the polyester. The sheetlike composite is preferably configured according to any embodiment of the sheetlike composite 1 of the invention. The polyester preferably has one or more features of the polyester of the sheetlike composite 1 of the invention. In particular, a carbon content of the polyester is preferably biobased to an extent of at least 25%, more preferably to an extent of at least 30%, more preferably to an extent of at least 40%, more preferably to an extent of at least 50%, more preferably to an extent of at least 60%, more preferably to an extent of at least 70%, even more preferably to an extent of at least 80%, most preferably to an extent of at least 90%. Further preferably, the polyester is selected from the group consisting of a polylactide (PLA), a polyhydroxyalkanoate, and a polyalkylene terephthalate, or from a combination of at least two of these. A preferred polyhydroxyalkanoate (PHA) is a polyhydroxybutyrate (PHB). A preferred polyhydroxybutyrate is poly-(R)-3-hydroxybutyrate (P(3HB)). A preferred polyalkylene terephthalate is polybutylene terephthalate or polyethylene terephthalate (PET), particular preference being given to PET. A preferred PET is a recycled PET or a bio-PET or both. Bio-PET refers in this connection to a PET having a carbon content which is biobased to an extent of at least 25%, more preferably to an extent of at least 30%.

A contribution to the achievement of at least one of the objects of the invention is made by an embodiment 1 of a use 7 of a polyester for production of a sheetlike composite for a food or drink product container, wherein the sheetlike composite comprises a polymer layer P comprising the polyester, wherein the polymer layer P
a. extends two-dimensionally within a layer plane,
b. has a first modulus of elasticity in a first layer direction which lies in the layer plane, and
c. has a further modulus of elasticity in a further layer direction which lies in the layer plane and is perpendicular to the first layer direction,
   wherein a ratio of the first modulus of elasticity to the further modulus of elasticity is within a range from 0.81 to 1.19, preferably from 0.82 to 1.18, more preferably from 0.83 to 1.17, more preferably from 0.84 to 1.16, more preferably from 0.85 to 1.15, more preferably from 0.86 to 1.14, more preferably from 0.87 to 1.17, more preferably from 0.88 to 1.12, more preferably from 0.89 to 1.11, more preferably from 0.9 to 1.1, more preferably from 0.91 to 1.09, more preferably from 0.92 to 1.08, more preferably from 0.93 to 1.07, more preferably from 0.94 to 1.06, even more preferably from 0.95 to 1.05, most preferably from 0.96 to 1.04. The first modulus of elasticity and the further modulus of elasticity are each determined by the method specified herein. The remarks made in respect of the first modulus of elasticity and the further modulus of elasticity for the sheetlike composite 1 are preferably applicable here analogously. The sheetlike composite preferably comprises, as mutually superposed layers in a direction from an outer face of the sheetlike composite to an inner face of the sheetlike composite,
a) a carrier layer, and
b) a barrier layer,
   wherein the sheetlike composite additionally comprises the polymer layer P. The polyester preferably has one or more features of the polyester of the sheetlike composite 1 of the invention. In particular, a carbon content of the polyester is preferably biobased to an extent of at least 25%, more preferably to an extent of at least 30%, more preferably to an extent of at least 40%, more preferably to an extent of at least 50%, more preferably to an extent of at least 60%, more preferably to an extent of at least 70%, even more preferably to an extent of at least 80%, most preferably to an extent of at least 90%. Further preferably, the polyester is selected from the group consisting of a polylactide (PLA), a polyhydroxyalkanoate, and a polyalkylene terephthalate, or from a combination of at least two of these. A preferred polyhydroxyalkanoate (PHA) is a polyhydroxybutyrate (PHB). A preferred polyhydroxybutyrate is poly-(R)-3-hydroxybutyrate (P(3HB)). A preferred polyalkylene terephthalate is polybutylene terephthalate or polyethylene terephthalate (PET), particular preference being given to PET. A preferred PET is a recycled PET or a bio-PET or both. Bio-PET refers in this connection to a PET having a carbon content which is biobased to an extent of at least 25%, more preferably to an extent of at least 30%. The sheetlike composite is preferably formed according to any embodiment of the sheetlike composite 1 of the invention.

Features which are described as preferred in one category of the invention, for example for the sheetlike composite 1, are likewise preferred in an embodiment of the further categories of the invention, for example an embodiment of the method 1 or 2 of the invention.

### Polyester

A useful polyester is in principle any polyester which is known to the person skilled in the art and is suitable for the use of the invention, especially for melt extrusion coating. A polyester here is a polymer having an ester function in its main chain. The stated function is defined here by the general form —[—CO—O—]—, i.e. by a carbon atom bonded to an oxygen atom by means of a double bond and to a further oxygen atom by means of a single bond. The repeat units having an ester function especially include

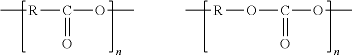

where n is a natural number which is at least 2.

### Chain Modifier

The term “chain modifier” used herein refers to a polymer chain modifier. A useful chain modifier is any chemical compound which is known to the person skilled in the art and seems suitable for use of the invention. A chain modifier is a chemical compound or a mixture of two or more chemical compounds from which the polymer P described herein or the polyester of the polymer layer P or of the polymer composition P is obtainable by means of a chemical reaction with a base polymer.

The polymer P or the polyester here especially has reduced anisotropy of its modulus of elasticity compared to the base polymer. The base polymer preferably has a modulus of elasticity A in a first direction, and a modulus of elasticity B in a direction perpendicular to the first direction. The polymer P obtained from the base polymer by means of the chain modifier, or the polyester, preferably has a modulus of elasticity C in the first direction, and a modulus of elasticity D in the direction perpendicular to the first direction. The ratio of the modulus of elasticity A to the modulus of elasticity B varies more here from the value of 1 than the ratio of the modulus of elasticity C to the modulus of elasticity D. This means that the modulus of elasticity of the polymer P or of the polyester is less anisotropic, i.e. more isotropic, than the modulus of elasticity of the base polymer. The first direction and further direction here are preferably each chosen such that the modulus of elasticity A has the maximum difference from the modulus of elasticity B, and the modulus of elasticity C has the maximum difference from the modulus of elasticity D.

Moreover, the aforementioned chemical reaction with the chain modifier preferably leads to a broadening of the molecular weight distribution of the polymer P or of the polyester compared to the base polymer, in that the molecular weight distribution forms a shoulder on the side of its maximum toward higher molecular weights, or such a shoulder increases in size. Alternatively or additionally, the chemical reaction with the chain modifier preferably leads to an increase in the degree of branching of the polymer P or of the polyester compared to the base polymer.

Further preferably, the polymer P or polyester, compared to the base polymer, even at lower shear frequencies, has a dependence of its shear viscosity on the shear frequency that is exhibited at least to a lesser degree, preferably not at all, by the base polymer at these low shear frequencies. The shear viscosity preferably decreases here with increasing shear frequency. Such a dependence is referred to as shear thinning (also called structural viscosity). This shear thinning is less marked in the case of the base polymer, and is preferably absent at the low shear frequencies. The aforementioned low shear frequencies are preferably in the range from 0.1 to 100 Hz. Moreover, the dependence of the shear viscosity of the polymer P or of the polyester on the shear frequency is preferably nonlinear or described by a monotonously decreasing function, preferably a strictly monotonously decreasing function. This is preferably also true within the shear frequency range from 0.1 to 100 Hz.

A preferred chain modifier is a chain extender, i.e. leads to extension of the polymer chains of the base polymer by means of a chemical reaction. A further preferred chain modifier is an organic chemical compound or a mixture of chemical compounds comprising at least one organic chemical compound, preferably organic chemical compounds only. A preferred chain modifier comprises a chemical group selected from the group consisting of an acrylate group, an epoxy group, and an anhydride group, or a combination of at least two of these. A preferred chain modifier has a molecular weight of less than 3.000. Suitable chain modifiers are frequently sold by polymer producers as “chain extenders”. Suitable chain modifiers are obtainable, for example, under the Joncryl® trade name from BASF SE or PMDA from Sigma Aldrich.

The polymer P is preferably a polyester, in which case the corresponding base polymer is preferably also a polyester. The abovementioned chemical reaction is also referred to herein as chain extension reaction. A preferred chain extension reaction is a polyaddition reaction.

### Sheetlike Composite

Useful sheetlike composites include all sheetlike composite materials that are conceivable within the context of the invention and seem suitable to the person skilled in the art for the use of the invention for production of dimensionally stable food and drink product containers. Sheetlike composites for production of food or drink product containers are also referred to as laminates. Sheetlike composites of this kind are frequently constructed from a thermoplastic polymer layer, a carrier layer usually consisting of cardboard or paper which endows the container with its dimensional stability, an adhesion promoter layer, a barrier layer and a further thermoplastic polymer layer, as disclosed inter alia in WO 90/09926 A2.

### Polymer P/Polymer Layer P/Polymer Composition P

In connection with the polymer P, the polymer layer P and the polymer composition P, the “P” is an index intended to identify the polymer meant, or the polymer layer or the polymer composition, with respect to the respective general designation and other polymers, polymer layers and polymer compositions. This index has no substantive meaning beyond that and is not an abbreviation. The polymer layer P of the invention is preferably a layer of the sheetlike composite which is based at least on the polymer P, or the polyester, and may comprise one or more further polymers. In addition, the polymer layer P may comprise one or more additives. The polymer layer P and polymer composition P here preferably each comprise the polymer P or the polyester. Further preferably, the polymer layer P is obtainable from the polymer composition P, more preferably by means of melt extrusion. The polymer composition P may be provided, for example, as a polymer melt, granules or powder, where the granules or powder are preferably converted to a polymer melt for superimposing of the carrier layer. The polymer layer P and the polymer composition P preferably each do not comprise any polymer blend. The polymer P or the polyester is preferably a homopolymer.

### Renewable Raw Material

The polymer P or the polyester is preferably obtainable from one or else from more renewable raw materials. A preferred renewable raw material is one selected from the group consisting of a plant constituent, a constituent of an animal body, and a human or animal secretion, or a combination of at least two of these. The polymer P, or the polyester, is preferably obtainable from the renewable raw material by means of a method comprising one or more selected from the group consisting of a monomer formation, a polymerization reaction, and a chain extension reaction, where preferably at least the monomer formation is effected in a fermentation. Additionally or alternatively, the aforementioned method is preferably a biogenic method.

### Layers of the Sheetlike Composite

The layers of the sheetlike composite preferably form a layer sequence. In addition, the layers of the sheetlike composite are preferably joined to one another. Two layers have been joined to one another when their adhesion to one another extends beyond van der Waals attraction forces. Layers that have been joined to one another preferably belong to a category selected from the group consisting of sealed to one another, adhesively bonded to one another, and compressed to one another, or a combination of at least two of these. Unless stated otherwise, in a layer sequence, the layers may follow one another indirectly, i.e. with one or at least two intermediate layers, or directly, i.e. with no intermediate layer. This is the case especially in the form of words in which one layer superimposes another layer. A form of words in which a layer sequence comprises enumerated layers means that at least the layers specified are present in the sequence specified. This form of words does not necessarily mean that these layers follow on directly from one another. A form of words in which two layers adjoin one another means that these two layers follow on from one another directly and hence with no intermediate layer. However, this form of words does not say anything as to whether or not the two layers have been joined to one another. Instead, these two layers may be in contact with one another. Preferably, however, these two layers are joined to one another.

### Polymer Layers

The term “polymer layer” refers hereinafter especially to the inner polymer layer, the intermediate polymer layer and the outer polymer layer, if these are not the polymer layer P. A preferred polymer is a polyolefin. The polymer layers may have further constituents. The polymer layers are preferably introduced into or applied to the sheetlike composite material in an extrusion method. The further constituents of the polymer layers are preferably constituents that do not adversely affect the behavior of the polymer melt on application as a layer. The further constituents may, for example, be inorganic compounds, such as metal salts, or further polymers, such as further thermoplastics. However, it is also conceivable that the further constituents are fillers or pigments, for example carbon black or metal oxides. Suitable thermoplastics for the further constituents especially include those that are readily processable by virtue of good extrusion characteristics. Among these, polymers obtained by chain polymerization are suitable, especially polyolefins, particular preference being given to cyclic olefin copolymers (COCs), polycyclic olefin copolymers (POCs), especially polyethylene and polypropylene, and very particular preference to polyethylene. Among the polyethylenes, preference is given to HDPE (high density polyethylene), MDPE (medium density polyethylene), LDPE (low density polyethylene), LLDPE (linear low density polyethylene) and VLDPE (very low density polyethylene) and mixtures of at least two of these. It is also possible to use mixtures of at least two thermoplastics. Suitable polymer layers have a melt flow rate (MFR) within a range from 1 to 25 g/10 min, preferably within a range from 2 to 20 g/10 min and more preferably within a range from 2.5 to 15 g/10 min, and a density within a range from 0.890 g/cm³ to 0.980 g/cm³, preferably within a range from 0.895 g/cm³ to 0.975 g/cm³, and further preferably within a range from 0.900 g/cm³ to 0.970 g/cm³. The polymer layers preferably have at least one melting temperature within a range from 80 to 155° C., preferably within a range from 90 to 145° C. and more preferably within a range from 95 to 135° C.

### Inner Polymer Layer

If the polymer layer P is not the inner polymer layer, the inner polymer layer is preferably based on thermoplastic polymers, where the inner polymer layer may comprise a particulate inorganic solid. However, it is preferable that the inner polymer layer comprises one or more thermoplastic polymers to an extent of at least 70% by weight, preferably at least 80% by weight and more preferably at least 95% by weight, based in each case on the total weight of the inner polymer layer. Preferably, the polymer or polymer mixture of the inner polymer layer has a density (according to ISO 1183-1:2004) within a range from 0.900 to 0.980 g/cm³, more preferably within a range from 0.900 to 0.960 g/cm³ and most preferably within a range from 0.900 to 0.940 g/cm³. The polymer is preferably a polyolefin, mPolymer or a combination of the two. The inner polymer layer preferably comprises a polyethylene or a polypropylene or both. In this context, a particularly preferred polyethylene is an LDPE. Preferably, the inner polymer layer comprises the polyethylene, polypropylene or both together in a proportion of at least 30% by weight, more preferably at least 40% by weight, most preferably at least 50% by weight, based in each case on the total weight of the inner polymer layer. Additionally or alternatively, the inner polymer layer preferably includes an HDPE, preferably in a proportion of at least 5% by weight, more preferably at least 10% by weight, more preferably at least 15% by weight, most preferably at least 20% by weight, based in each case on the total weight of the inner polymer layer. Additionally or alternatively to one or more of the aforementioned polymers, the inner polymer layer preferably comprises a polymer prepared by means of a metallocene catalyst, preferably an mPE. Preferably, the inner polymer layer comprises the mPE in a proportion of at least 3% by weight, more preferably at least 5% by weight, based in each case on the total weight of the inner polymer layer. In this case, the inner polymer layer may comprise 2 or more, preferably 2 or 3, of the aforementioned polymers in a polymer blend, for example at least a portion of the LDPE and the mPE, or at least a portion of the LDPE and the HDPE. In addition, the inner polymer layer may include 2 or more, preferably 3, mutually superposed sublayers which preferably form the inner polymer layer. These sublayers are preferably layers obtained by coextrusion.

In a preferred configuration of the sheetlike composite, the inner polymer layer comprises, in a direction from the outer face of the sheetlike composite to the inner face of the sheetlike composite, a first sublayer comprising an LDPE in a proportion of at least 50% by weight, preferably of at least 60% by weight, more preferably of at least 70% by weight, even more preferably of at least 80% by weight, most preferably of at least 90% by weight, based in each case on the weight of the first sublayer; and a further sublayer comprising a blend, wherein the blend comprises an LDPE in a proportion of at least 30% by weight, preferably of at least 40% by weight, more preferably of at least 50% by weight, even more preferably of at least 60% by weight, most preferably of at least 65% by weight, and an mPE in a proportion of at least 10% by weight, preferably of at least 15% by weight, more preferably of at least 20% by weight, most preferably of at least 25% by weight, based in each case on the weight of the blend. In this case, the further sublayer comprises the blend preferably in a proportion of at least 50% by weight, preferably of at least 60% by weight, more preferably of at least 70% by weight, even more preferably of at least 80% by weight, most preferably of at least 90% by weight, based in each case on the weight of the further sublayer. More preferably, the further sublayer consists of the blend.

In a further preferred configuration of the sheetlike composite, the inner polymer layer comprises, in a direction from the outer face of the sheetlike composite to the inner face of the sheetlike composite, a first sublayer comprising an HDPE in a proportion of at least 30% by weight, preferably of at least 40% by weight, more preferably of at least 50% by weight, even more preferably of at least 60% by weight, most preferably of at least 70% by weight, and an LDPE in a proportion of at least 10% by weight, preferably of at least 15% by weight, more preferably of at least 20% by weight, based in each case on the weight of the first sublayer; a second sublayer comprising an LDPE in a proportion of at least 50% by weight, preferably of at least 60% by weight, more preferably of at least 70% by weight, even more preferably of at least 80% by weight, most preferably of at least 90% by weight, based in each case on the weight of the second sublayer; and a third sublayer comprising a blend, wherein the blend comprises an LDPE in a proportion of at least 30% by weight, preferably of at least 40% by weight, more preferably of at least 50% by weight, even more preferably of at least 60% by weight, most preferably of at least 65% by weight, and an mPE in a proportion of at least 10% by weight, preferably of at least 15% by weight, more preferably of at least 20% by weight, most preferably of at least 25% by weight, based in each case on the weight of the blend. In this case, the third sublayer comprises the blend preferably in a proportion of at least 50% by weight, preferably of at least 60% by weight, more preferably of at least 70% by weight, even more preferably of at least 80% by weight, most preferably of at least 90% by weight, based in each case on the weight of the third sublayer. More preferably, the third sublayer consists of the blend.

### Outer Polymer Layer

If the polymer layer P is not the outer polymer layer, the outer polymer layer preferably comprises a polyethylene or a polypropylene or both. Preferred polyethylenes here are LDPE and HDPE and mixtures of these. A preferred outer polymer layer comprises an LDPE to an extent of at least 50% by weight, preferably to an extent of at least 60% by weight, more preferably to an extent of at least 70% by weight, still more preferably to an extent of at least 80% by weight, most preferably to an extent of at least 90% by weight, based in each case on the weight of the outer polymer layer.

### Polymer Interlayer

If the polymer layer P is not the polymer interlayer, the polymer interlayer preferably comprises a polyethylene or a polypropylene or both. In this context, a particularly preferred polyethylene is an LDPE. Preferably, the polymer interlayer comprises the polyethylene or the polypropylene or both together in a proportion of at least 20% by weight, more preferably at least 30% by weight, more preferably at least 40% by weight, more preferably at least 50% by weight, more preferably at least 60% by weight, more preferably at least 70% by weight, more preferably at least 80% by weight, most preferably at least 90% by weight, based in each case on the total weight of the polymer interlayer. Additionally or alternatively, the polymer interlayer preferably comprises an HDPE, preferably in a proportion of at least 10% by weight, more preferably at least 20% by weight, more preferably at least 30% by weight, more preferably at least 40% by weight, more preferably at least 50% by weight, more preferably at least 60% by weight, more preferably at least 70% by weight, more preferably at least 80% by weight, most preferably at least 90% by weight, based in each case on the total weight of the polymer interlayer. In this context, the polymer interlayer comprises the aforementioned polymers preferably in a polymer blend.

### Barrier Layer

The barrier layer used may be any material which is suitable for a person skilled in the art for this purpose and which has sufficient barrier action, especially with respect to oxygen. For this purpose, the barrier layer preferably has an oxygen permeation rate of less than 50 cm³/(m² day atm), preferably less than 40 cm³/(m² day atm), more preferably less than 30 cm³/(m² day atm), more preferably less than 20 cm³/(m² day atm), more preferably less than 10 cm³/(m² day atm), even more preferably less than 3 cm³/(m² day atm), most preferably not more than 1 cm³/(m² day atm).

The barrier layer is preferably selected from
a. a polymer barrier layer;
b. a metal layer;
c. a metal oxide layer; or
d. a combination of at least two of a. to c.

If the barrier layer, according to alternative a., is a polymer barrier layer, this preferably comprises at least 70% by weight, especially preferably at least 80% by weight and most preferably at least 95% by weight of at least one polymer which is known to the person skilled in the art for this purpose, especially for aroma or gas barrier properties suitable for packaging containers. Useful polymers, especially thermoplastics, here include N- or O-bearing polymers, either alone or in mixtures of two or more. According to the invention, it may be found to be advantageous when the polymer barrier layer has a melting temperature within a range from more than 155 to 300° C., preferably within a range from 160 to 280° C. and especially preferably within a range from 170 to 270° C.

Further preferably, the polymer barrier layer has a basis weight within a range from 2 to 120 g/m², preferably within a range from 3 to 60 g/m², especially preferably within a range from 4 to 40 g/m² and further preferably from 6 to 30 g/m². Further preferably, the polymer barrier layer is obtainable from melts, for example by extrusion, especially layer extrusion. Further preferably, the polymer barrier layer may also be introduced into the sheetlike composite via lamination. It is preferable in this context that a film is incorporated into the sheetlike composite. In another embodiment, it is also possible to select polymer barrier layers obtainable by deposition from a solution or dispersion of polymers.

Suitable polymers preferably include those having a weight-average molecular weight, determined by gel permeation chromatography (GPC) by means of light scattering, within a range from 3·10³ to 1·10⁷ g/mol, preferably within a range from 5·10³ to 1·10⁶ g/mol and especially preferably within a range from 6·10³ to 1·10⁵ g/mol. Suitable polymers especially include polyamide (PA) or polyethylene vinyl alcohol (EVOH) or a mixture thereof.

Among the polyamides, useful PAs are all of those that seem suitable to the person skilled in the art for the use according to the invention. Particular mention should be made here of PA 6, PA 6.6, PA 6.10, PA 6.12, PA 11 or PA 12 or a mixture of at least two of these, particular preference being given to PA 6 and PA 6.6 and further preference to PA 6. PA 6 is commercially available, for example, under the Akulon®, Durethan® and Ultramid® trade names. Additionally suitable are amorphous polyamides, for example MXD6, Grivory® and Selar® PA. It is further preferable that the PA has a density within a range from 1.01 to 1.40 g/cm³, preferably within a range from 1.05 to 1.30 g/cm³ and especially preferably within a range from 1.08 to 1.25 g/cm³. It is also preferable that the PA has a viscosity number within a range from 130 to 250 ml/g and preferably within a range from 140 to 220 ml/g.

Useful EVOHs include all the EVOHs that seem suitable to the person skilled in the art for the use according to the invention. Examples of these are commercially available, inter alia, under the EVAL™ trade names from EVAL Europe NV, Belgium, in a multitude of different versions, for example the EVAL™ F104B or EVAL™ LR171B types. Preferred EVOHs have at least one, two, more than two or all of the following properties:
an ethylene content within a range from 20 to 60 mol %, preferably from 25 to 45 mol %;
a density within a range from 1.0 to 1.4 g/cm³, preferably from 1.1 to 1.3 g/cm³;
a melting point within a range from more than 155 to 235° C., preferably from 165 to 225° C.;
an MFR value (210° C./2.16 kg when T_{S(EVOH)}<230° C.; 230° C./2.16 kg when 210° C.<T_{S(EVOH)}<230° C.) within a range from 1 to 25 g/10 min, preferably from 2 to 20 g/10 min;
an oxygen permeation rate within a range from 0.05 to 3.2 cm³·20 μm/(m²·day·atm), preferably in a range from 0.1 to 1 cm³·20 μm/(m²·day·atm).

Preferably at least one polymer layer, further preferably the inner polymer layer, or preferably all polymer layers, has/have a melting temperature below the melting temperature of the barrier layer. This is especially true when the barrier layer is formed from polymer. The melting temperatures of the at least one polymer layer, especially the inner polymer layer, and the melting temperature of the barrier layer preferably differ here by at least 1 K, especially preferably by at least 10 K, still more preferably by at least 50 K, even more preferably by at least 100 K. The temperature difference should preferably be chosen to be only of such an amount that there is no melting of the barrier layer, especially no melting of the polymer barrier layer, during the folding.

According to alternative b., the barrier layer is a metal layer. Suitable metal layers are in principle all layers comprising metals which are known to the person skilled in the art and which can provide high light opacity and oxygen impermeability. In a preferred embodiment, the metal layer may take the form of a foil or a deposited layer, for example after a physical gas phase deposition. The metal layer is preferably an uninterrupted layer. In a further preferred embodiment, the metal layer has a thickness within a range from 3 to 20 μm, preferably within a range from 3.5 to 12 μm and especially preferably within a range from 4 to 10 μm.

Metals selected with preference are aluminum, iron or copper. A preferred iron layer may be a steel layer, for example in the form of a foil. Further preferably, the metal layer is a layer comprising aluminum. The aluminum layer may appropriately consist of an aluminum alloy, for example AlFeMn, AlFe1.5Mn, AlFeSi or AlFeSiMn. The purity is typically 97.5% or higher, preferably 98.5% or higher, based in each case on the overall aluminum layer. In a particular configuration, the metal layer consists of an aluminum foil. Suitable aluminum foils have a ductility of more than 1%, preferably of more than 1.3% and especially preferably of more than 1.5%, and a tensile strength of more than 30 N/mm², preferably more than 40 N/mm² and especially preferably more than 50 N/mm². Suitable aluminum foils exhibit in the pipette test a droplet size of more than 3 mm, preferably more than 4 mm and especially preferably of more than 5 mm. Suitable alloys for producing aluminum layers or foils are commercially available under the designations EN AW 1200, EN AW 8079 or EN AW 8111 from Hydro Aluminium Deutschland GmbH or Amcor Flexibles Singen GmbH. In the case of a metal foil as a barrier layer, it is possible to provide an adhesion promoter layer between the metal foil and a closest polymer layer on one and/or both sides of the metal foil.

Further preferably, the barrier layer selected, according to alternative c., may be a metal oxide layer. Useful metal oxide layers include all metal oxide layers that are familiar and seem suitable to the person skilled in the art for achieving a barrier effect with respect to light, vapor and/or gas. Especially preferred are metal oxide layers based on the metals already mentioned above, aluminum, iron or copper, and those metal oxide layers based on titanium oxide or silicon oxide compounds. A metal oxide layer is produced by way of example by vapor deposition of metal oxide on a polymer layer, for example an oriented polypropylene film. A preferred method for this purpose is physical gas phase deposition.

In a further preferred embodiment, the metal layer or metal oxide layer may take the form of a layer composite composed of one or more polymer layers with a metal or metal oxide layer. Such a layer is obtainable, for example, by vapor deposition of metal on a polymer layer, for example an oriented polypropylene film. A preferred method for this purpose is physical gas phase deposition.

### Carrier Layer

The carrier layer used may be any material which is suitable for a person skilled in the art for this purpose and which has sufficient strength and stiffness to impart stability to the container to such an extent that the container in the filled state essentially retains its shape. This is, in particular, a necessary feature of the carrier layer since the invention relates to the technical field of dimensionally stable containers. Dimensionally stable containers of this kind should in principle be distinguished from pouches and bags, which are usually produced from thin films. As well as a number of plastics, preference is given to plant-based fibrous materials, especially pulps, preferably limed, bleached and/or unbleached pulps, with paper and cardboard being especially preferred. Accordingly, a preferred carrier layer comprises a multitude of fibers. The basis weight of the carrier layer is preferably within a range from 120 to 450 g/m², especially preferably within a range from 130 to 400 g/m² and most preferably within a range from 150 to 380 g/m². A preferred cardboard generally has a single-layer or multilayer structure and may have been coated on one or both sides with one or else more than one outer layer. In addition, a preferred cardboard has a residual moisture content of less than 20% by weight, preferably of 2% to 15% by weight and especially preferably of 4% to 10% by weight, based on the total weight of the cardboard. An especially preferred cardboard has a multilayer structure. Further preferably, the cardboard has, on the surface facing the environment, at least one lamina, but more preferably at least two laminas, of a cover layer known to the person skilled in the art as a “coating slip”. Further, a preferred cardboard has a Scott bond value (according to Tappi T403 um) within a range from 100 to 360 J/m², preferably from 120 to 350 J/m² and especially preferably from 135 to 310 J/m². By virtue of the aforementioned ranges, it is possible to provide a composite from which it is possible to fold a container with high integrity, easily and in low tolerances.

The carrier layer is characterized by a bending resistance which can be measured with a bending tester according to ISO 2493-2:2011 at a bending angle of 15°. The bending tester used is an L&W Bending Tester code 160 from Lorentzen & Wettre, Sweden. The carrier layer preferably has a bending resistance in a first direction in a range from 80 to 550 mN. In the case of a carrier layer that comprises a multitude of fibers, the first direction is preferably a direction of orientation of the fibers. A carrier layer that comprises a multitude of fibers also preferably has a bending resistance in a second direction, perpendicular to the first direction, in a range from 20 to 300 mN. The samples used for measuring the bending resistance with the above measuring device have a width of 38 mm and a clamping length of 50 mm. A preferred sheetlike composite with the carrier layer has a bending resistance in the first direction in a range from 100 to 700 mN. Further preferably, the aforementioned sheetlike composite has a bending resistance in the second direction in a range from 50 to 500 mN. The samples of the sheetlike composite used for measuring with the above measuring device also have a width of 38 mm and a clamping length of 50 mm.

### Outer Face

The outer face of the sheetlike composite is a surface of a ply of the sheetlike composite which is intended to be in contact with the environment of the container in a container to be produced from the sheetlike composite. This does not oppose, in individual regions of the container, folding of the outer faces of various regions of the composite against one another or joining thereof to one another, for example sealing thereof to one another.

### Inner Face

The inner face of the sheetlike composite is a surface of a ply of the sheetlike composite which is intended to be in contact with the contents of the container, preferably a food or drink product, in a container to be produced from the sheetlike composite.

### Polyolefin

A preferred polyolefin is a polyethylene (PE) or a polypropylene (PP) or both. A preferred polyethylene is one selected from the group consisting of an LDPE, an LLDPE, and an HDPE, or a combination of at least two of these. A further preferred polyolefin is an mPolyolefin (polyolefin prepared by means of a metallocene catalyst). Suitable polyethylenes have a melt flow rate (MFR=MFI−melt flow index) within a range from 1 to 25 g/10 min, preferably within a range from 2 to 20 g/10 min and especially preferably within a range from 2.5 to 15 g/10 min, and a density within a range from 0.910 g/cm³ to 0.935 g/cm³, preferably within a range from 0.912 g/cm³ to 0.932 g/cm³, and further preferably within a range from 0.915 g/cm³ to 0.930 g/cm³.

mPolymer

An mPolymer is a polymer which has been prepared by means of a metallocene catalyst. A metallocene is an organometallic compound in which a central metal atom is arranged between two organic ligands, for example cyclopentadienyl ligands. A preferred mPolymer is an mPolyolefin, preferably an mPolyethylene or an mPolypropylene or both. A preferred mPolyethylene is one selected from the group consisting of an mLDPE, an mLLDPE, and an mHDPE, or a combination of at least two of these.

Melting Temperatures of mPolyolefin

A preferred mPolyolefin is characterized by at least one first melting temperature and a second melting temperature. Preferably, the mPolyolefin is characterized by a third melting temperature in addition to the first and second melting temperature. A preferred first melting temperature is within a range from 84 to 108° C., preferably from 89 to 103° C., more preferably from 94 to 98° C. A preferred further melting temperature is within a range from 100 to 124° C., preferably from 105 to 119° C., more preferably from 110 to 114° C.

### Adhesion/Adhesion Promoter Layer

An adhesion promoter layer is a layer of the sheetlike composite comprising at least one adhesion promoter in a sufficient amount, so that the adhesion promoter layer improves adhesion between layers adjoining the adhesion promoter layer. For this purpose, the adhesion promoter layer preferably comprises an adhesion promoter polymer. Accordingly, the adhesion promoter layers are preferably polymeric layers. An adhesion promoter layer may be present between layers of the sheetlike composite which do not directly adjoin one another, preferably between the barrier layer and the inner polymer layer. Useful adhesion promoters in an adhesion promoter layer include all polymers which are suitable for producing a firm bond through functionalization by means of suitable functional groups, through the forming of ionic bonds or covalent bonds with a surface of a respective adjacent layer. Preferably, these comprise functionalized polyolefins, especially acrylic acid copolymers, which have been obtained by copolymerization of ethylene with acrylic acids such as acrylic acid, methacrylic acid, crotonic acid, acrylates, acrylate derivatives or carboxylic anhydrides that bear double bonds, for example maleic anhydride, or at least two of these. Among these, preference is given to polyethylene-maleic anhydride graft polymers (EMAH), ethylene-acrylic acid copolymers (EAA) or ethylene-methacrylic acid copolymers (EMAA), which are sold, for example, under the Bynel® and Nucrel® 0609HSA trade names by DuPont or the Escor® 6000ExCo trade name by ExxonMobil Chemicals.

Further preferably, useful adhesion promoters also include ethylene-alkyl acrylate copolymers. The alkyl group selected is preferably a methyl, ethyl, propyl, i-propyl, butyl, i-butyl or a pentyl group. Further preferably, the adhesion promoter layer may include mixtures of two or more different ethylene-alkyl acrylate copolymers. Likewise preferably, the ethylene-alkyl acrylate copolymer may have two or more different alkyl groups in the acrylate function, for example an ethylene-alkyl acrylate copolymer in which both methyl acrylate units and ethyl acrylate units occur in the same copolymer.

According to the invention, it is preferable that the adhesion between the carrier layer, a polymer layer or the barrier layer and the next layer in each case is at least 0.5 N/15 mm, preferably at least 0.7 N/15 mm and especially preferably at least 0.8 N/15 mm. In one configuration of the invention, it is preferable that the adhesion between a polymer layer and a carrier layer is at least 0.3 N/15 mm, preferably at least 0.5 N/15 mm and especially preferably at least 0.7 N/15 mm. It is further preferable that the adhesion between the barrier layer and a polymer layer is at least 0.8 N/15 mm, preferably at least 1.0 N/15 mm and especially preferably at least 1.4 N/15 mm. If the barrier layer indirectly follows a polymer layer with an adhesion promoter layer in between, it is preferable that the adhesion between the barrier layer and the adhesion promoter layer is at least 1.8 N/15 mm, preferably at least 2.2 N/15 mm and especially preferably at least 2.8 N/15 mm. In a particular configuration, the adhesion between the individual layers is sufficiently strong that the carrier layer is torn apart in an adhesion test, called a cardboard fiber tear in the case of a cardboard as the carrier layer.

### Extruding/Extruder

A useful extruder in the context of the inventors is any extruder which is known to the person skilled in the art and seems suitable for the use of the invention. An extruder is an apparatus for shaping a mass, preferably a polymer mass, by means of pressing through a shaping orifice. A preferred extruder is a processing extruder or a compounding extruder or both. Processing extruders serve mainly for shaping and often take the form of single-shaft extruders. Compounding extruders serve for chemical and/or physical modification of the mass by means of a chemical or physical operation. A preferred chemical operation here is a chemical reaction. A preferred physical operation here is mixing or degassing or both. In connection with use 2 of the invention and embodiment 5 of method 1 or 2, particular preference is given to a compounding extruder. In this connection, a preferred chemical reaction as the chemical operation is a chain extension reaction. A preferred extruder is selected from the group consisting of a piston extruder, a screw extruder, a cascade extruder, and a planetary roll extruder, or a combination of at least two of these. A preferred screw extruder is a barrier screw extruder, or a co-rotating or counter-rotating twin-screw extruder. A further preferred extruder comprises one, or two, or more than two shafts, where each of these shafts bears an extrusion tool, for example an extruder screw, or is in one-piece form together with the extrusion tool. In connection with use 2 of the invention and embodiment 5 of method 1 or 2, very particular preference is given to a screw extruder, preferably a twin-screw extruder, more preferably a co-rotating twin-screw extruder.

A melt extrusion coating operation is an application of a mass by means of pressing of a melt that forms the mass through a shaping orifice of an extruder onto a substrate, such that a two-dimensional layer superimposing the substrate is obtained from the mass. In the case of a polymer composition P as the mass, the mass is preferably melted for extrusion coating. In the extrusion, the polymers are typically heated to temperatures of 210 to 350° C., measured in the molten polymer film beneath the exit from the extruder die. The extrusion can be effected by means of extrusion tools which are known to those skilled in the art and are commercially available, for example extruders, extruder screws, feed blocks, etc. At the end of the extruder, there is preferably an opening through which the polymer melt is pressed. The opening may have any shape that allows extrusion of the polymer melt. For example, the opening may be angular, oval or round. The opening is preferably in the form of a slot of a funnel. Once the melt layer has been applied to the substrate layer by means of the above-described method, the melt layer is left to cool down for the purpose of heat-setting, this cooling preferably being effected by quenching via contact with a surface which is kept at a temperature within a range from 5 to 50° C., especially preferably within a range from 10 to 30° C. Subsequently, at least the flanks are separated from the surface. The separation may be carried out in any way that is familiar and appears suitable to a person skilled in the art for separating the flanks quickly, as precisely as possible and cleanly. Preferably, the separation is effected by means of a knife, laser beam or waterjet, or a combination of two or more thereof, the use of knives being especially preferable, especially a circular knife.

### Lamination

According to the invention, the carrier layer may be superimposed by the barrier layer by lamination. In this case, the prefabricated carrier and barrier layers are joined with the aid of a suitable laminating agent. A preferred laminating agent comprises an intermediate polymer composition from which a polymer interlayer is preferably obtained.

### Colorant

Useful colorants include both solid and liquid colorants that are known to the person skilled in the art and are suitable for the present invention. According to DIN 55943:2001-10, colorant is the collective term for all coloring substances, especially for dyes and pigments. A preferred colorant is a pigment. A preferred pigment is an organic pigment. Pigments that are notable in connection with the invention are especially the pigments mentioned in DIN 55943:2001-10 and those mentioned in “Industrial Organic Pigments, Third Edition” (Willy Herbst, Klaus Hunger Copyright © 2004 WILEY-VCH Verlag GmbH & Co. KGaA, Weinheim ISBN: 3-527-30576-9). A pigment is a colorant that is preferably insoluble in the application medium. A dye is a colorant that is preferably soluble in the application medium.

### Folding of the Sheetlike Composite

The folding of the sheetlike composite is preferably performed in a temperature range from 10 to 50° C., preferably in a range from 15 to 45° C. and especially preferably in a range from 20 to 40° C. This can be achieved by the sheetlike composite being at a temperature in the aforementioned ranges. It is also preferred that a folding tool, preferably together with the sheetlike composite, is at a temperature in the aforementioned range. For this purpose, the folding tool preferably does not have a heating means. Rather, the folding tool or else the sheetlike composite or both may be cooled. It is also preferred that the folding is performed at a temperature of at most 50° C., as “cold folding”, and the joining takes place at over 50° C., preferably over 80° C. and especially preferably over 120° C., as “hot sealing”. The aforementioned conditions, and especially temperatures, preferably also apply in the environment of the folding, for example in the housing of the folding tool.

What is meant here by “folding” in accordance with the invention is an operation in which an elongated crease, forming an angle, is made in the folded sheetlike composite, preferably by means of a folding edge of a folding tool. For this purpose, often two adjoining faces of a sheetlike composite are bent increasingly towards one another. The folding produces at least two adjoining fold faces that can then be joined at least in sub-regions to form a container region. According to the invention, the joining can be performed by any measure which appears suitable to the person skilled in the art and which allows a join that is as gas- and liquid-tight as possible. The joining can be performed by sealing or adhesive bonding or a combination of the two measures. In the case of sealing, the join is created by means of a liquid and the solidification thereof. In the case of adhesive bonding, chemical bonds form between the interfaces or surfaces of the two articles to be joined and create the join. It is often advantageous in the case of sealing or adhesive bonding to press together the faces that are to be sealed or adhesively bonded.

### Joining

A useful joining method is any joining method that seems suitable to the person skilled in the art for use of the invention, by means of which a sufficiently firm join can be obtained. A preferred join method is any selected from the group consisting of sealing, adhesive bonding, and pressing, or a combination of at least two of these. In the case of sealing, the join is created by means of a liquid and the solidification thereof. In the case of adhesive bonding, chemical bonds form between the interfaces or surfaces of the two articles to be joined and create the join. It is often advantageous in the case of sealing or adhesive bonding to press together the faces that are to be sealed or adhesively bonded. A preferred method of pressing two layers is compression of a first surface of a first of the two layers on to a second surface of the second of the two layers that faces the first surface over at least 20%, preferably at least 30%, more preferably at least 40%, more preferably at least 50%, more preferably at least 60%, more preferably at least 70%, even more preferably at least 80%, even more preferably at least 90%, most preferably at least 95%, of the first surface. A particularly preferred joining method is sealing. A preferred sealing method comprises, as steps, heating, overlaying and pressing, the steps preferably being effected in this sequence. Another sequence is likewise conceivable, especially the sequence of overlaying, heating and pressing. A preferred heating method is heating of a polymer layer, preferably a thermoplastic layer, more preferably a polyethylene layer or a polypropylene layer or both. A further preferred heating method is heating of a polyethylene layer to a temperature within a range from 80 to 140° C., more preferably from 90 to 130° C., most preferably from 100 to 120° C. A further preferred heating method is heating of a polypropylene layer to a temperature within a range from 120 to 200° C., more preferably from 130 to 180° C., most preferably from 140 to 170° C. A further preferred heating method is effected to a sealing temperature of the polymer layer. A preferred heating method can be effected by means of radiation, by means of hot gas, by means of contact with a hot solid, by means of mechanical vibrations, preferably by means of ultrasound, by convection, or by means of a combination of at least two of these measures. A particularly preferred heating method is effected by inducement of an ultrasound vibration.

### Irradiation

In the case of irradiation, any type of radiation suitable to the person skilled in the art for softening of the plastics of the polymer layers present is useful. Preferred types of radiation are IR and UV rays, and microwaves. In the case of the IR rays that are also used for IR welding of sheetlike composites, wavelength ranges of 0.7 to 5 μm should be mentioned. In addition, it is possible to use laser beams within a wavelength range from 0.6 to less than 1.6 μm. In connection with the use of IR rays, these are generated by various suitable sources that are known to the person skilled in the art. Short-wave radiation sources in the range from 1 to 1.6 μm are preferably halogen sources. Medium-wave radiation sources within the range from >1.6 to 3.5 μm are, for example, metal foil sources. Long-wave radiation sources in the range of >3.5 μm that are used are frequently quartz sources. Lasers are being used ever more frequently. For instance, diode lasers within a wavelength range from 0.8 to 1 Nd:YAG lasers at about 1 μm and CO₂ lasers at about 10.6 μm are in use. High-frequency techniques with a frequency range from 10 to 45 MHz, frequently within a power range from 0.1 to 100 kW, are also in use.

### Ultrasound

In the case of ultrasound, the following treatment parameters are preferred:
P1 a frequency within a range from 5 to 100 kHz, preferably within a range from 10 to 50 kHz and more preferably within a range from 15 to 40 kHz;
P2 an amplitude within a range from 2 to 100 μm, preferably within a range from 5 to 70 μm and more preferably within a range from 10 to 50 μm;
P3 an oscillation time (being the period of time within which an oscillation body such as a sonotrode or inductor has a contact oscillation effect on the sheetlike composite) within a range from 50 to 1000 ms, preferably within a range from 100 to 600 ms and more preferably within a range from 150 to 300 ms.

On suitable selection of the radiation and oscillation conditions, it is advantageous to take account of the intrinsic resonances of the plastics and to select frequencies close to these.

Contact with a Solid

Heating via contact with a solid can be effected, for example, by means of a heating plate or heating mold in direct contact with the sheetlike composite, which releases the heat to the sheetlike composite.

### Hot Gas

The hot gas, preferably hot air, can be directed onto the sheetlike composite by means of suitable blowers, exit openings or nozzles, or a combination of these. Frequently, contact heating and the hot gas are used simultaneously. For example, a holding device for a container precursor formed from the sheetlike composite, through which hot gas flows and which is heated as a result and releases the hot gas through suitable openings, can heat the sheetlike composite through contact with the wall of the holding device and the hot gas. In addition, the container precursor can also be heated by fixing the container precursor with a container precursor holder and directing the flow from one or two or more hot gas nozzles provided in the container precursor holder onto the regions of the container precursor that are to be heated.

### Food or Drink Product

In the context of the invention, the sheetlike composite and the container precursor are preferably designed for production of a, preferably closed, food or drink product container. In addition, the container of the invention is preferably a, preferably closed, food or drink product container. Food and drink products include all kinds of food and drink known to those skilled in the art for human consumption and also animal feeds. Preferred food and drink products are liquid above 5° C., for example milk products, soups, sauces, non-carbonated drinks.

### Container Precursor

A container precursor is a precursor of the container which arises in the course of production of a, preferably closed, container. In this context, the container precursor includes the sheetlike composite preferably in the form of a blank. In this context, the sheetlike composite may be in an unfolded or folded state. A preferred container precursor has been cut to size and is designed for production of a single, preferably closed, container. A preferred container precursor which has been cut to size and is designed for production of a single container is also referred to as a shell or sleeve. In this context, the shell or sleeve comprises the sheetlike composite in folded form. In addition, the container precursor preferably takes the form of an outer shell of a prism. A preferred prism is a cuboid. Moreover, the shell or sleeve comprises a longitudinal seam and is open in a top region and a base region. A typical container precursor which has been cut to size and is designed for production of a multitude of containers is often referred to as a tube.

A further preferred container precursor is open, preferably in a top region or a top region, more preferably in both. A preferred container precursor is in the form of a shell or tube or both. A further preferred container precursor includes the sheetlike composite in such a way that the sheetlike composite has been folded at least once, preferably at least twice, more preferably at least 3 times, most preferably at least 4 times. A preferred container precursor is in one-piece form. More preferably, a base region of the container precursor is in a one-piece design with a lateral region of the container precursor.

### Container

The, preferably closed, container of the invention may have a multitude of different forms, but preference is given to an essentially cuboidal structure. In addition, the full area of the container may be formed from the sheetlike composite, or it may have a two-part or multipart construction. In the case of a multipart construction, it is conceivable that, as well as the sheetlike composite, other materials are also used, for example plastic, which can be used especially in the top or base regions of the container. In this context, however, it is preferable that the container is formed from the sheetlike composite to an extent of at least 50%, especially preferably to an extent of at least 70% and further preferably to an extent of at least 90% of the area. In addition, the container may have a device for emptying the contents. This may be formed, for example, from a polymer or mixture of polymers and be attached on the outer face of the container. It is also conceivable that this device has been integrated into the container by “direct injection molding”. In a preferred configuration, the container of the invention has at least one edge, preferably from 4 to 22 or else more edges, especially preferably from 7 to 12 edges. Edges in the context of the present invention are understood to mean regions which arise in the folding of a surface. Examples of edges include the longitudinal contact regions between two wall surfaces of the container in each case, also referred to as longitudinal edges herein. In the container, the container walls are preferably the surfaces of the container framed by the edges. Preferably, the interior of a container of the invention comprises a food or drink product. Preferably, the container does not comprise any lid or base, or either, that has not been formed in one piece with the sheetlike composite. A preferred container comprises a food or drink product.

### Hole

The at least one hole that is provided in the carrier layer according to preferred embodiments may have any shape that is known to a person skilled in the art and suitable for various closures or drinking straws. In the context of the invention, particular preference is given to a hole for passage of a drinking straw. The holes often have rounded portions in plan view. Thus, the holes may be essentially circular, oval, elliptical or drop-shaped. The shape of the at least one hole in the carrier layer usually also predetermines the shape of the opening that is produced either by an openable closure which is connected to the container and through which the content of the container is dispensed from the container after opening, or by a drinking straw in the container. Consequently, the openings of the opened container often have shapes that are comparable to or even the same as the at least one hole in the carrier layer. Configurations of the sheetlike composite with a single hole primarily serve for letting out the food or drink product located in the container that is produced from the sheetlike composite. A further hole may be provided, especially for letting air into the container while the food or drink product is being let out.

In the context of superimposing the at least one hole of the carrier layer, it is preferred that the hole-covering layers are at least partly joined to one another, preferably to an extent of at least 30%, preferably at least 70% and especially preferably at least 90%, of the area formed by the at least one hole. It is also preferred that the hole-covering layers are joined to one another at the edges of the at least one hole and preferably lie against the edges in a joined manner, in order in this way to achieve an improved leak-tightness over a join that extends across the entire area of the hole. The hole-covering layers are often joined to one another over the region that is formed by the at least one hole in the carrier layer. This leads to a good leak-tightness of the container formed from the composite, and consequently to a desired long shelf life of the food or drink products kept in the container. Preferably, the at least one hole has a diameter within a range from 3 to 30 mm, more preferably from 3 to 25 mm, more preferably from 3 to 20 mm, more preferably from 3 to 15 mm, most preferably from 3 to 10 mm. In this case, the diameter of the hole is the longest of the straight lines which begins and ends at the edge of the hole and runs through the geometric center of the hole.

### Opening/Opening Aid

The opening of the container is usually brought about by at least partially destroying the hole-covering layers that cover the at least one hole. This destruction can be effected by cutting, pressing into the container or pulling out of the container. The destruction can be effected by means of an opening aid which is connected to the container and is arranged in the region of the at least one hole, usually above the at least one hole, for example also by a drinking straw which is pushed through the hole-covering layers. It is also preferred in one configuration of the invention that an opening aid is provided in the region of the at least one hole. It is preferred here that the opening aid is provided on the surface area of the composite that represents the outer face of the container. The container also preferably comprises a closure, for example a lid, on the outer face of the container. It is in this case preferred that the closure covers the hole at least partially, preferably completely. Consequently, the closure protects the hole-covering layers, which are less robust in comparison with the regions outside the at least one hole, from damaging mechanical effects. For opening the hole-covering layers that cover the at least one hole, the closure often comprises the opening aid. Suitable as such an opening aid are for example hooks for tearing out at least part of the hole-covering layers, edges or cutting edges for cutting into the hole-covering layers or spikes for puncturing the hole-covering layers, or a combination of at least two of these. These opening aids are often mechanically coupled to a screw lid or a cap of the closure, for example by way of a hinge, so that the opening aids act on the hole-covering layers to open the closed container when the screw lid or the cap is actuated. Closure systems of this kind, comprising composite layers covering a hole, openable closures that cover this hole and have opening aids, are sometimes referred to in the specialist literature as “overcoated holes” with “applied fitments”.

### Test Methods

The following test methods were used within the context of the invention. Unless stated otherwise, the measurements were conducted at an ambient temperature of 23° C., an ambient air pressure of 100 kPa (0.986 atm) and a relative air humidity of 50%.

### Separation of Individual Layers

If individual layers of a laminate—for example the polymer layer P, the barrier layer, the outer polymer layer, the inner polymer layer or the polymer interlayer—are to be examined herein, the layer to be examined is first separated from the laminate as described below. Three specimens of the sheetlike composite are cut to size. For this purpose, unless stated otherwise, unfolded and ungrooved regions of the sheetlike composite are used. Unless stated otherwise, the specimens have dimensions of 4 cm×4 cm. Should other dimensions of the layer to be examined be necessary for the examination to be conducted, sufficiently large specimens are cut out of the laminate. The specimens are introduced into an acetic acid bath (30% acetic acid solution: 30% by weight of CH₃COOH, remainder to 100% by weight H₂O) heated to 60° C. for 30 minutes. This detaches the layers from one another. If required, the layers may also be cautiously manually pulled apart here. Should the desired layer not be sufficiently readily detachable, as an alternative, new specimens are used and these are treated in an ethanol bath (99% ethanol) as described above. If residues of the carrier layer (especially in the case of a cardboard layer as carrier layer) are present on the layer to be examined (for example the outer polymer layer or the polymer interlayer), these are cautiously removed with a brush. One sample of size sufficient for the examination to be conducted (unless stated otherwise, with an area of 4 cm²) is cut out of each of the three films thus prepared. These samples are then stored at 23° C. for 4 hours and hence dried. Subsequently, the three samples can be examined. Unless stated otherwise, the result of the examination is the arithmetic mean of the results for the three samples.

### MFR

MFR is measured according to standard ISO 1133-1:2012, Method A (mass determination method), unless stated otherwise at 190° C. and 2.16 kg.

### Density

Density is measured according to standard ISO 1183-1:2013.

### Melting Temperature

Melting temperature is determined on the basis of the DSC method ISO 11357-1, -5. The instrument is calibrated according to the manufacturer's instructions on the basis of the following measurements:
temperature indium—onset temperature,
heat of fusion indium,
temperature zinc—onset temperature.

The measurement curve recorded may have multiple local maxima (melt peaks), i.e. multiple melting temperatures. If a melting temperature above a particular value is required herein, this condition is met when one of the melting temperatures measured is above this value. If a melting temperature of a polymer layer, a polymer composition or a polymer is referenced herein, what is meant in the case of multiple melting temperatures measured (melt peaks), unless stated otherwise, is always the highest melting temperature.

### Viscosity Number of PA

The viscosity number of PA is measured according to the standard DIN EN ISO 307 (2013) in 95% sulfuric acid.

### Molecular Weight Distribution

Molecular weight distribution is measured by gel permeation chromatography by means of light scattering: ISO 16014-3/-5 (2009 September).

### Moisture Content of the Cardboard

The moisture content of the cardboard is measured according to standard ISO 287:2009.

### Adhesion

The adhesion of two adjacent layers is determined by fixing them in a 90° peel test instrument, for example the Instron “German rotating wheel fixture”, on a rotatable roller which rotates at 40 mm/min during the measurement. The samples had been cut beforehand into strips 15 mm wide. On one side of the sample, the laminas are detached from one another and the detached end is clamped in a tensile device directed vertically upward. A measuring instrument to determine the tensile force is attached to the tensile device. As the roller rotates, the force needed to separate the laminas from one another is measured. This force corresponds to the adhesion of the layers to one another and is reported in N/15 mm. The separation of the individual layers can be effected mechanically, for example, or by means of a controlled pretreatment, for example by soaking the sample in 30% acetic acid at 60° C. for 3 min.

### Detection of Colorants

Detection of organic colorants can be conducted in accordance with the methods described in “Industrial Organic Pigments, Third Edition” (Willy Herbst, Klaus Hunger Copyright © 2004 WILEY-VCH Verlag GmbH & Co. KGaA, Weinheim ISBN: 3-527-30576-9).

### Biobased Carbon Content

Whether and in what proportion the carbon content of the polymer P, of the polymer layer P or of the polymer composition P is biobased is determined according to standard ASTM D6866-12 Method B.

### Oxygen Permeation Rate

Oxygen permeation rate is determined according to standard ASTM D3985-05 (2010). The sample to be examined, unless stated otherwise, is taken from an ungrooved and unfolded region of the laminate. In addition, the sample to be examined is tested with the side facing outward in the laminate facing the test gas. The area of the sample is 50 cm². The measurements are conducted at an ambient temperature of 23° C., an ambient air pressure of 100 kPa (0.986 atm) and a relative air humidity of 50%. The test instrument is an Ox-Tran 2/22 from Mocon, Neuwied, Germany. The measurement is conducted without compressed air compensation. For the measurements, samples at ambient temperature are used. Further settings and factors that affect the measurement—especially the others listed under point 16 of the standard ASTM D3985-05 (2010)—are defined by the instrument used and the proper use and maintenance thereof according to the manufacturer's handbook.

### Modulus of Elasticity

The modulus of elasticity is determined by means of a tensile test with a Tira test 28025 universal tensile tester (Tira GmbH; Eisfelder Strasse 23/25; 96528 Schalkau, Germany; load cell: 1 kN). For this purpose, the polymer layer to be examined is first separated from the composite as described above. 10 samples are produced here with dimensions of 15 mm×40 mm. 5 of the specimens in each case are measured in the first layer direction, and 5 in the further layer direction. For the respective measurement, the specimen is clamped into the tensile tester in the layer direction to be examined. The testing rate is V1=100 mm/min. For each layer direction, the arithmetic average is formed from the values obtained for the 5 samples. The moduli of elasticity are obtained in the first layer direction and the further layer direction.

### Neck-in

In the melt extrusion coating with the polymer composition P, the neck-in value refers to the constriction of the polymer film formed by the polymer composition P between the extruder die exit and substrate, i.e. sheetlike composite precursor, on each side of the film. For the measurement, the distance between extruder die exit and film is 15 cm. The constriction is calculated from the difference between the nozzle width and the film width on the substrate, both in mm. The smaller the value, the more easily it is possible to coat broad substrates and the more effectively it is thus possible to utilize the production plant. To determine the neck-in value, the width of the film on the substrate is measured and calculated by the following formula:

$$Neck \text{-} In ( m m ) = \frac{a - b}{2}$$

where a is the nozzle width in mm, and b the film width on substrate in mm. The nozzle width a here is the longest extent of the extruder nozzle slot.

### Intrinsic Viscosity

Intrinsic viscosity is determined to ASTM D4603-03.

### Shear Viscosity

Detailed explanations of the rheological methods can be found, inter alia, in “The Rheology Handbook: For Users of Rotational and Oscillatory Rheometers, 2nd revised edition” (ISBN 3-87870-174-8). The shear rheology measurements are conducted in oscillation tests with a Discovery HR-3 rheometer from TA Instruments, having plate-plate geometry with a diameter of 25 mm. If reference is made herein to the shear viscosity of a polymer layer or a polymer composition, what is meant is always the dynamic shear viscosity measurable by means of plate-plate geometry.

### Determinations of the Shear Viscosity of Polyethylene Terephthalate or its Derivatives:

The sample is first conditioned in the measuring instrument. For this purpose, the sample is first melted at the measurement temperature (bioPET: 270° C.; rPET to 260° C.) for 5 min and a plate separation of 1750 μm, and then the excess that has swollen up between the plates is removed. The sample height (measurement gap) during the measurement is 1700 μm. First of all, an amplitude sweep is performed with deformation increasing stepwise from 0.1% to 100% and at a constant angular frequency of 0.2 rad/s, in order to ascertain the linear-viscoelastic region (LVE). In this region, the rheological properties are independent of deformation, and so it is possible to ascertain a deformation suitable for the frequency sweep. The frequency sweep is then run at a deformation of 4% and an angular frequency range of 0.1 to 100 rad/s.

### Determinations of the Shear Viscosity of Polylactic Acid or its Derivatives:

The sample is first conditioned in the measuring instrument. For this purpose, the sample is first melted at the measurement temperature of 195° C. for 5 min and a plate separation of 1750 μm, and then the excess that has swollen up between the plates is removed. The sample height (measurement gap) during the measurement is 1700 μm. First of all, an amplitude sweep is performed with deformation increasing stepwise from 0.1% to 100% and at a constant angular frequency of 0.2 rad/s, in order to ascertain the linear-viscoelastic region (LVE). In this region, rheological properties are independent of deformation, and so it is possible to ascertain a deformation suitable for the frequency sweep. The frequency sweep is then run at a deformation of 1% and an angular frequency range of 0.1 to 100 rad/s.

Three samples are measured in each case in order to assure the reproducibility of the tests.

### Leak Tightness

The test medium used for leak tightness testing is Kristalloel 60 from Shell Chemicals with methylene blue. For this test, 250 containers are produced from the laminate to be examined as described below for the examples and comparative examples and closed. The closed containers are then each cut open around their circumference such that a container portion open at the top including the closed base region is obtained. This container portion is filled with about 20 ml of the test medium and stored for 24 hours. After the storage time, the container portions are then inspected by the naked eye on the outside of the base region as to whether the test medium, in the case of leaking of the base region, has produced blue colors. The result reported for this test is the number of the 250 identical containers that show leakage after 24 hours.

### Stability to Ambient Humidity

The stability of the containers to ambient humidity is tested by means of a compression test. For this test, 5 identical containers are produced as described below for the examples and comparative examples, filled with water and closed. Subsequently, the containers are stored at a relative air humidity of the ambient air of 50% at a temperature of 23° C. for 24 hours. Immediately thereafter, the compression test is conducted. The test serves to ascertain the compression resistance along the longitudinal axis of the closed container and can be used to assess the durability of filled containers in the static case of storage and in the dynamic case of transport. Compression pressure testing is conducted on the individual containers in accordance with DIN EN ISO12048. The test instrument used is a TIRAtest 28025 (Tira GmbH; Eisfelder Strasse 23/25; 96528 Schalkau, Germany). The average of the maximum fracture load (load value) from the 5 identical containers is determined. This describes the value that leads to failure of the containers examined.

### Ink Adhesive Strength

The adhesive strength of an ink layer is understood to mean a resistance of the ink layer to forces that occur when an adhesive strip is torn off the surface of the ink layer. The adhesive strip used in the test is Tesaband 4104 adhesive tape, width 20 mm, from the manufacturer Beiersdorf AG, Hamburg. The sample to be tested is placed with the ink layer upward on a hard, smooth and flat base. For each test run, a strip of the Tesaband 4104 adhesive tape is stuck onto the outer layer at least over a length of 30 mm and pressed on homogeneously by thumb. The test is effected within 30 seconds after the Tesafilm adhesive tape has been stuck on. Longer residence times on the outer layer can lead to different results. The test is effected either in that
a) the adhesive strip is pulled off sharply at an angle of 90°, or
b) the adhesive strip is pulled off by gradual peeling (at an angle of less than 45° relative to the ink layer).

For each of the two test methods a) and b), 3 test runs are conducted at different points in the ink layer. The results are assessed by the naked eye using the scale below. The results improve from 1 to 5:

5—ink layer not pulled off

4—spots of ink layer pulled off at individual sites

3—distinct areas of ink layer pulled off at individual sites

2—ink layer pulled off over large areas

1—ink layer pulled off completely, based on the area of the adhesive strip

These 6 results are used to form the arithmetic mean, which corresponds to the result of the measurement.

### Printability

The printability of the outer polymer layer is evaluated by ascertaining the dots in the print matrix that have not been printed in the printing of the decoration in the intaglio printing method. For this purpose, the printed decoration is studied under a light microscope. Five fully printed regions of the laminate to be examined with a size of 10 mm×10 mm are examined. An unprinted dot in the print matrix corresponds in this case to a missing dot. The missing dots are counted for each of the five regions. The arithmetic mean (average value) of the five measurements corresponds to the value “missing dots”. The higher this value, the poorer the printability of the outer polymer layer of the laminate.

### Stress-Cracking Corrosion

15 ungrooved and unfolded laminate samples in each case are cut to the dimensions of 68 mm×38 mm. The cutting is effected here in such a way that the length of 68 mm is oriented at right angles to the cardboard fiber direction. The samples are each folded once in such a way that the outer decorative layer faces itself. Thus folded, the samples are fixed with a paperclip and immersed in 100% detergent (Pricol perfekt from Henkel, Dusseldorf, Germany) for up to one week. The samples are immersed into the detergent to a depth of 15 mm. 5 of the samples in each case are checked for stress cracks under a stereomicroscope after 24 h, 48 h and 7 days. Stress cracks are manifested in that changes in the form of cracks, hairline cracks or flaking are visible on the still-folded sample in the region of the fold on the side of the laminate remote from the decorated side (stretched region). Evaluation is effected by the following scale:

3—no stress cracks after 7 days

2—stress cracks after 48 h

1—stress cracks after 24 h

### Opening Test

The carrier layer was provided with a hole as described below for the examples and comparative examples, to which an opening aid was applied according to EP 1 812 298 B1. According to paragraph [0002], this opens the container with a puncturing and cutting motion through the membrane that covers the hole. In the case of optimal function, about 90% of the membrane radius defined by the cutting ring is cut through, and there is only a connection to the container at one point. The membrane folds away to the side and the product can be poured out without disruption. In the event of material selection not in accordance with the invention, restrictions can arise in the opening of the container. In each case, the symbols mean:

“+” good opening characteristics, and

“−” poor opening characteristics.

Poor opening characteristics can mean high expenditure of force, a membrane that has not been completely cut through, or threads and projections resulting from stretched polymer layers.

### Biodegradability

Biodegradability is tested according to standard DIN EN 13432. According to the standard, biodegradability means that a material must have been degraded to an extent of more than 90% to give water, carbon dioxide (CO₂) and biomass after a fixed period of time under defined temperature, oxygen and moisture conditions in the presence of microorganisms or fungi.

The invention is described in more detail hereinafter by examples and drawings, although the examples and drawings do not imply any restriction of the invention. Moreover, the drawings, unless stated otherwise, are not to scale.

Preparation of Treated Biopolyesters from Untreated Biopolyesters as Base Polymers

TABLE 1
Untreated biopolyesters that are used as base polymers in
the context of the examples and comparative examples,
and chain modifiers suitable for treatment for these with
their dosage in % by weight, based on the weight of
the mixture of base polymer and chain modifier, and the
temperature used for extrusion of the treated polyester obtained

| | | Extrusion |
|---|---|---|
| Untreated biopolyester = base | Chain modifier | temperature |
| polymer | with dosage | [° C.] |
| Ingeo 4044D from | 0.3% by weight of | 230 |
| Nature Works | Joncryl ADR 4468 | |
| Biomer B300 from Biomer | 0.3% by weight of | 200 |
| | Joncryl ADR 4468 | |
| Globio ® BCB 80 from | 0.7% by weight | 290 |
| FKUR | of pyromellitic | |
| | anhydride | |
| MOPET-A SSP 0.82+ from | 0.7% by weight | 290 |
| Morssinkhof-Rymoplast | of pyromellitic | |
| | anhydride | |

The untreated biopolyesters (base polymers) specified in table 1, by treatment with the respective chain modifier specified for the purpose in the dosage likewise specified, are used to obtain treated biopolyesters for the use of the invention. This treatment is effected in each case in the extrusion coating system used for the production of the laminates. For this purpose, base polymer and chain modifier are introduced into the extruder together, and the extrusion is conducted at the temperature listed in table 1. The treated polyester thus obtained is pelletized and is thus available for the melt extrusion coating described below for production of the laminates. In the case of use of one of the treated polyesters obtained as described above, this extrusion coating is also effected with the extrusion temperature specified in table 1.

If the above base polymers are used without prior treatment with a chain modifier (comparative examples), these are each referred to as “untreated”. The base polymers treated with the corresponding above-specified chain modifiers are referred to as “treated”.

In addition, in the evaluations below, “++” always means a more advantageous result than “+”, “+” a more advantageous result than “−”, and “−” a more advantageous result than “−−”.

### Polymer Layer P as Outer Polymer Layer

In examples 1 to 8 (inventive) and comparative examples 1 to 11 (non-inventive), the layer referred to herein as polymer layer P is used as outer polymer layer. The polymer layer P conforms to the invention here only in the inventive examples.

### Laminate Construction

For the examples (inventive) and comparative examples (non-inventive) in which the polymer layer P is used as outer polymer layer, laminates having the layer construction specified in table 2 below are each prepared by a layer extrusion method.

TABLE 2
Construction of the laminates from the examples and comparative
examples in which polymer layer P is used as outer polymer layer

| | | Basis weight |
|---|---|---|
| Layer designation | Material | [g/m²] |
| Outer polymer | see Table 3 | 15 |
| layer = polymer | | |
| layer P | | |
| Carrier layer | Cardboard: Stora Enso Natura T Duplex | 210 |
| | double-coated, Scott bond 200 J/m², | |
| | residual moisture content 7.5% | |
| Polymer | LDPE 23L430 from Ineos GmbH, | 18 |
| interlayer | Cologne, Germany | |
| First adhesion | Escor 6000 HSC from Exxon Mobil | 3 |
| promoter | Corporation as adhesion promoter | |
| layer | polymer A | |
| Barrier layer | aluminum, EN AW 8079 from Hydro | here: |
| | Aluminium Deutschland GmbH | thickness |
| | | 6 μm |
| Second adhesion | Co-extrudate (1) Escor 6000 HSC from | (1) - 4 |
| promoter layer | Exxon Mobil Corporation as adhesion | (2) - 22 |
| | promoter polymer B, and (2) LDPE | |
| | 19N430 from Ineos GmbH, Cologne, | |
| | Germany | |
| Inner polymer | Blend of (1) 65% by weigh of LDPE | 10 |
| layer | 19N430 from Ineos GmbH, Cologne, | |
| | Germany and (2) 35% by weight of | |
| | Eltex 1315 AZ from Ineos | |
| | GmbH, Cologne ,Germany | |

### Composition of the Outer Polymer Layer

Table 3 specifies, for each example and comparative example in which the polymer layer P is used as outer polymer layer, the compositions used in the polymer layer P and in the polymer composition P from which the polymer layer P is obtained.

TABLE 3
Composition of polymer layer P in the laminates from the examples and comparative
examples in which polymer layer P is used as outer polymer layer

| | Polymer layer P/polymer composition P |
|---|---|
| Comparative | 100% by weight of untreated LDPE 19N430 from Ineos GmbH, Cologne, |
| example 1 | Germany |
| Comparative | 100% by weight of untreated Braskem LD4000A (LDPE) from Braskem |
| example 2 | |
| Comparative | 100% by weight of untreated Ingeo 4044D (PLA) from Nature Works |
| example 3 | |
| Comparative | 50% by weight of untreated and 50% by weight of treated Ingeo 4044D (PLA) |
| example 4 | from Nature Works |
| Example 1 | 30% by weight of untreated and 70% by weight of treated Ingeo 4044D (PLA) |
| | from Nature Works |
| Example 2 | 100% by weight of treated Ingeo 4044D (PLA) from Nature Works |
| Comparative | 100% by weight of untreated Biomer B300 (PHB) from Biomer |
| example 5 | |
| Comparative | 50% by weight of untreated and 50% by weight of treated Biomer B300 (PHB) |
| example 6 | from Biomer |
| Example 3 | 30% by weight of untreated and 70% by weight of treated Biomer B300 (PHB) |
| | from Biomer |
| Example 4 | 100% by weight of treated Biomer B300 (PHB) from Biomer |
| Comparative | 100% by weight of untreated DSM Arnite ® A02 307 (PET) |
| example 7 | |
| Comparative | 100% by weight of untreated Globio ® BCB80 (PET), FKUR |
| example 8 | |
| Comparative | 50% by weight of untreated and 50% by weight of treated Globio ® BCB80 |
| example 9 | (PET), FKUR |
| Example 5 | 30% by weight of untreated and 70% by weight of treated Globio ® BCB80 |
| | (PET), FKUR |
| Example 6 | 100% by weight of treated Globio ® BCB80 (PET), FKUR |
| Comparative | 100% by weight of untreated MOPET-A SSP 0.82+ (rPET) from Morssinkhof- |
| example 10 | Rymoplast |
| Comparative | 50% by weight of untreated and 50% by weight of treated MOPET-A SSP 0.82+ |
| example 11 | (rPET) from Morssinkhof-Rymoplast |
| Example 7 | 30% by weight of untreated and 70% by weight of treated MOPET-A SSP 0.82+ |
| | (rPET) from Morssinkhof-Rymoplast |
| Example 8 | 100% by weight of treatedMOPET-A SSP 0.82+ (rPET) from Morssinkhof- |
| | Rymoplast |

### Laminate Production

The laminates are produced with an extrusion coating system from Davis Standard. The extrusion temperature here, unless stated otherwise for the purpose of treatment with the chain modifier, is within a range from about 280 to 330° C. In the first step, the carrier layer is provided with one pouring hole for each container to be produced and then the outer polymer layer is applied to the carrier layer. In the second step, the polymer interlayer is applied together with the adjoining adhesion promoter layer and the barrier layer to the carrier layer that has been coated with the outer polymer layer beforehand. In the last step, the inner polymer layer is applied to the barrier layer together with the adjacent adhesion promoter layer. For application of the individual layers, the polymers or polymer blends are melted in an extruder. In the case of application of one polymer or polymer blend in a layer, the resultant melt is transferred via a feed block into a nozzle and extruded onto the carrier layer. In the case of application of two or more polymers or polymer blends in a layer, the resultant melts are combined by means of a feed block and then co-extruded onto the carrier layer. By the methods specified above, the MFR or intrinsic viscosity of the polymer composition P used for production of the outer polymer layer and the neck-in thereof are ascertained in the melt extrusion coating operation. In addition, what is called the edge waving of the polymer composition P in the melt extrusion coating operation is assessed. The less marked the occurrence of this phenomenon the better, since a smoother and more homogeneous outer polymer layer is obtained over the substrate area. If edge waving is too marked, neck-in cannot reasonably be to determined. The results of the above studies relating to the processability of the polymer compositions P of the examples and comparative examples are summarized in table 4.

TABLE 4
Properties relating to processability of the polymer compositions P
of the examples and comparative examples in which the
polymer layer P is used as outer polymer layer by means
of melt extrusion coating

| | | Low edge | Intrinsic | MFR |
|---|---|---|---|---|
| | Neck-in [mm] | waving | viscosity [dl/g] | [g/10 min] |
| Comparative | 20 | ++ | | 7.5 |
| example 1 | | | | |
| Comparative | 20 | ++ | | 7.5 |
| example 2 | | | | |
| Comparative | not determinable | −− | | 3 |
| example 3 | | | | |
| Comparative | 35 | − | | 4.5 |
| example 4 | | | | |
| Example 1 | 30 | + | | 4.5 |
| Example 2 | 17 | ++ | | 6 |
| Comparative | not determinable | −− | | 10 |
| example 5 | | | | |
| Comparative | 37.5 | − | | 11 |
| example 6 | | | | |
| Example 3 | 32.5 | + | | 11 |
| Example 4 | 22.5 | ++ | | 12 |
| Comparative | not determinable | −− | 0.85 | |
| example 7 | | | | |
| Comparative | not determinable | −− | 0.8 | |
| example 8 | | | | |
| Comparative | 35 | − | 0.79 | |
| example 9 | | | | |
| Example 5 | 30 | + | 0.79 | |
| Example 6 | 25 | ++ | 0.79 | |
| Comparative | not determinable | −− | 0.85 | |
| example 10 | | | | |
| Comparative | 37.5 | − | 0.85 | |
| example 11 | | | | |
| Example 7 | 32.5 | + | 0.85 | |
| Example 8 | 27.5 | ++ | 0.85 | |

Samples of the outer polymer layer are separated as described above from the laminates from the examples and comparative examples produced as described above, and the ratios therein of the first modulus of elasticity in the first layer direction to the further modulus of elasticity in the further layer direction are determined by the above test method. In the determination of the moduli of elasticity, the first layer direction is always chosen such that this corresponds to the machine direction (MD) of the extrusion coating operation. Accordingly, the further layer direction is chosen such that it corresponds to cross direction (CD). The results of the further studies are reported in table 5.

TABLE 5
Rheological properties of the polymer layers P of the laminates
from the examples and comparative examples in which
polymer layer P is used as outer polymer layer

| | First modulus of elasticity/further |
|---|---|
| | modulus of elasticity of the |
| | polymer layer P |
| Comparative example 1 | 0.93 |
| Comparative example 2 | 0.96 |
| Comparative example 3 | 0.67 |
| Comparative example 4 | 0.80 |
| Example 1 | 0.91 |
| Example 2 | 1.02 |
| Comparative example 5 | 0.61 |
| Comparative example 6 | 0.75 |
| Example 3 | 0.89 |
| Example 4 | 0.97 |
| Comparative example 7 | 0.72 |
| Comparative example 8 | 0.68 |
| Comparative example 9 | 0.79 |
| Example 5 | 0.91 |
| Example 6 | 1.03 |
| Comparative example 10 | 0.69 |
| Comparative example 11 | 0.78 |
| Example 7 | 0.91 |
| Example 8 | 0.98 |

Crucial aspects of the environmental compatibility of a laminate and the containers produced therefrom are the creation of the materials used for production of the laminate, but also the utilizability of these materials after the containers have been disposed of. The biobased carbon content of the polymer layer P is used herein as a measure of the proportion in which the polymer(s) of the respective polymer layer P have been obtained from renewable raw materials, i.e. a measure of the environmental compatibility of the creation of the polymer(s) used. The biobased carbon content is determined after the polymer layer P has been separated from the laminate by the method described above. For assessment of environmental compatibility, the utilizability of the polymers used after the end of container use also has to be considered. Environmentally compatible utilization can be affected by biodegradation of the material or by chemical recycling. Biodegradability is tested by the test method specified above. Chemical recyclability means that the material can be divided chemically into its individual constituents such that these are available for production of a new material by means of polymerization. Results for the 3 above-discussed aspects of environmental compatibility of the polymer layers P of laminates from the examples and comparative examples with the polymer layer P as outer polymer layer are summarized in table 6 below.

In addition, the laminates from the examples and comparative examples produced as described above are printed with a decoration on the outer polymer layer by the intaglio printing method. For this purpose, a decoration with 60 matrix dots per cm and an area coverage of 30% is used. Prior to the printing, the outer polymer layer to be printed is not subjected to any treatment for improvement of ink adhesion, for example a corona treatment. The studies specified above relating to the adhesive strength of the ink and relating to printability (missing matrix dots) of the outer polymer layer are conducted on the printed laminates. The results of these studies are likewise reported in table 6.

TABLE 6
Further properties of the polymer layers P of the laminates from the
examples and comparative examples in which polymer layer
P is used as outer polymer layer

| | Biobased | | Chemical | | |
|---|---|---|---|---|---|
| | carbon | Biodegrad- | recy- | Missing | |
| | content | ability | clability | matrix | |
| | of the | of the | of the | dots | Ink |
| | polymer | polymer | polymer | [per 100 | adhesive |
| | layer P [%] | layer P | layer P | mm²] | strength |
| Comparative | 0 | − | − | 13 | 1 |
| example 1 | | | | | |
| Comparative | 100 | − | − | 14 | 1 |
| example 2 | | | | | |
| Comparative | 100 | + | + | 200 | 3 |
| example 3 | | | | | |
| Comparative | 100 | + | + | 150 | 3 |
| example 4 | | | | | |
| Example 1 | 100 | + | + | 34 | 4 |
| Example 2 | 100 | + | + | 14 | 5 |
| Comparative | 100 | + | + | 210 | 3 |
| example 5 | | | | | |
| Comparative | 100 | + | + | 176 | 3 |
| example 6 | | | | | |
| Example 3 | 100 | + | + | 45 | 5 |
| Example 4 | 100 | + | + | 19 | 5 |
| Comparative | 0 | − | + | 178 | 5 |
| example 7 | | | | | |
| Comparative | 30 | − | + | 187 | 3 |
| example 8 | | | | | |
| Comparative | 30 | − | + | 146 | 3 |
| example 9 | | | | | |
| Example 5 | 30 | − | + | 32 | 4 |
| Example 6 | 30 | − | + | 25 | 4 |
| Comparative | 0 (recycled) | − | + | 167 | 3 |
| example 10 | | | | | |
| Comparative | 0 (recycled) | − | + | 145 | 3 |
| example 11 | | | | | |
| Example 7 | 0 (recycled) | − | + | 29 | 4 |
| Example 8 | 0 (recycled) | − | + | 19 | 4 |

### Container Production

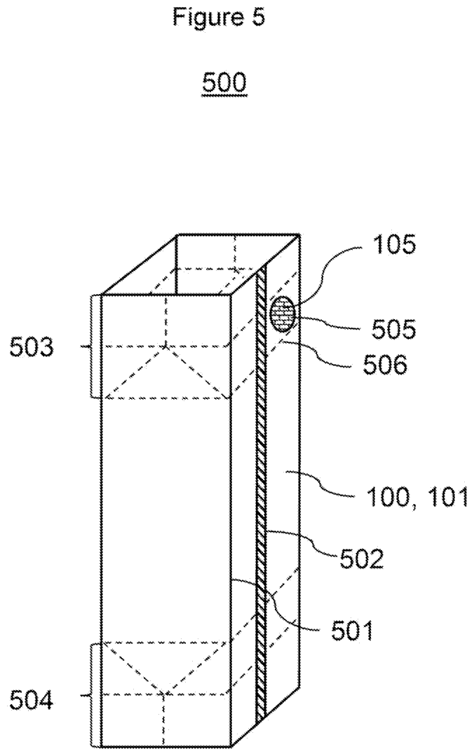

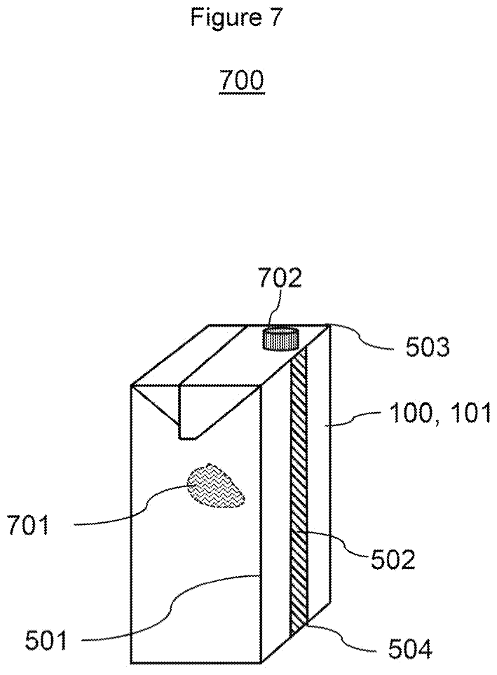

Grooves, especially longitudinal grooves, are introduced into the printed laminates obtained as described above on the outside (side of the outer polymer layer). A groove pattern is introduced here for each container to be produced from the laminate. In addition, the grooved laminate is divided into blanks for individual containers, each blank including one of the above holes. By folding along the 4 longitudinal grooves of each and every blank and sealing of overlapping fold faces by introduction of heat, a shell-shaped container precursor of the shape shown in FIG. 5 with a longitudinal seam is obtained in each case. This shell is used to produce a closed container of the shape (brick type) shown in FIG. 7 in a CFA 712 standard filling machine, SIG Combibloc, Linnich. This involves producing a base region by folding and closing by heat-sealing. This gives rise to a beaker open at the top. The beaker is sterilized with hydrogen peroxide. In addition, the beaker is filled with water. By folding and ultrasound sealing, the top region of the beaker including the hole is closed and hence a closed container is obtained. An opening aid of the type disclosed in EP 1 812 298 B1 is stuck to this container over the hole with a Euromelt 510 adhesive from Henkel, Dusseldorf. The containers obtained are examined by the method specified above for their stability to ambient humidity, and subjected to the opening test described above. The results of these studies are listed in table 7.

TABLE 7
Properties of the containers produced from laminates
according to the examples and comparative examples
with polymer layer P as outer polymer layer

| | Load value [N] for statement | |
|---|---|---|
| | of stability to ambient humidity | Opening test |
| Comparative example 1 | 140 | + |
| Comparative example 2 | 140 | + |
| Comparative example 3 | 45 | −− |
| Comparative example 4 | 90 | − |
| Example 1 | 135 | + |
| Example 2 | 150 | + |
| Comparative example 5 | 53 | − |
| Comparative example 6 | 91 | − |
| Example 3 | 133 | + |
| Example 4 | 140 | + |
| Comparative example 7 | 90 | − |
| Comparative example 8 | 60 | − |
| Comparative example 9 | 96 | − |
| Example 5 | 129 | + |
| Example 6 | 139 | + |
| Comparative example 10 | 54 | − |
| Comparative example 11 | 102 | − |
| Example 7 | 133 | + |
| Example 8 | 145 | + |

### Polymer Layer P as Polymer Interlayer

In examples 9 to 16 (inventive) and comparative examples 12 to 22 (non-inventive), the layer referred to herein as polymer layer P is used as polymer interlayer. The polymer layer P conforms to the invention here only in the inventive examples.

### Laminate Construction

For the examples (inventive) and comparative examples (non-inventive) in which the polymer layer P is used as polymer interlayer, laminates having the layer construction specified in table 8 below are each prepared by a layer extrusion method.

TABLE 8
Construction of the laminates from the examples and comparative
examples in which polymer layer P is used as polymer interlayer

| | | Basis |
|---|---|---|
| Layer | | weight |
| designation | Material | [g/m²] |
| Outer polymer | LDPE 19N430 from Ineos GmbH, | 15 |
| layer | Cologne, Germany | |
| Carrier layer | Cardboard: Stora Enso Natura T Duplex | 210 |
| | double-coated, Scott bond 200 J/m², | |
| | residual moisture content 7.5% | |
| Polymer | see Table 9 | 20 |
| interlayer = | | |
| polymer layer P | | |
| First adhesion | Escor 6000 HSC from Exxon Mobil | 3 |
| promoter layer | Corporation as adhesion promoter | |
| | polymer A | |
| Barrier layer | aluminum, EN AW 8079 from Hydro | here: |
| | Aluminium Deutschland GmbH | thickness |
| | | 6 μm |
| Second | Co-extrudate (1) Escor 6000 HSC from | (1)-4 |
| adhesion | Exxon Mobil Corporation as adhesion | (2)-22 |
| promoter layer | promoter polymer B, and (2) LDPE | |
| | 19N430 from Ineos GmbH, Cologne, | |
| | Germany | |
| Inner polymer | Blend of (1) 65% by weight of LDPE | 10 |
| layer | 19N430 from Ineos GmbH, Cologne, | |
| | Germany and (2) 35% by weight of | |
| | Eltex 1315 AZ from Ineos GmbH, | |
| | Cologne, Germany | |

### Composition of the Polymer Interlayer

Table 9 specifies, for each example and comparative example in which polymer layer P is used as polymer interlayer, the compositions used in the polymer layer P and in the polymer composition P from which the polymer layer P is obtained.

TABLE 9
Composition of polymer layer P in the laminates
from the examples and comparative examples in
which polymer layer P is used as polymer interlayer

| | Polymer layer P/polymer composition P |
|---|---|
| Comparative | 100% by weight of untreated LDPE 19N430 from Ineos |
| example 12 | GmbH, Cologne, Germany |
| Comparative | 100% by weight of untreated Braskem LD4000A (LDPE) |
| example 13 | from Braskem |
| Comparative | 100% by weight of untreated Ingeo 4044D (PLA) from |
| example 14 | Nature Works |
| Comparative | 50% by weight of untreated and 50% by weight of treated |
| example 15 | Ingeo 4044D (PLA) from Nature Works |
| Example 9 | 30% by weight of untreated and 70% by weight of treated |
| | Ingeo 4044D (PLA) from Nature Works |
| Example 10 | 100% by weight of treated Ingeo 4044D (PLA) from |
| | Nature Works |
| Comparative | 100% by weight of untreated Biomer B300 (PHB) |
| example 16 | from Biomer |
| Comparative | 50% by weight of untreated and 50% by weight of treated |
| example 17 | Biomer B300 (PHB) from Biomer |
| Example 11 | 30% by weight of untreated and 70% by weight of treated |
| | Biomer B300 (PHB) from Biomer |
| Example 12 | 100% by weight of treated Biomer B300 (PHB) from |
| | Biomer |
| Comparative | 100% by weight of untreated DSM Arnite ® A02 307 |
| example 18 | (PET) |
| Comparative | 100% by weight of untreated Globio ® BCB80 (PET), |
| example 19 | FKUR |
| Comparative | 50% by weight of untreated and 50% by weight of treated |
| example 20 | Globio ® BCB80 (PET), FKUR |
| Example 13 | 30% by weight of untreated and 70% by weight of treated |
| | Globio ® BCB80 (PET), FKUR |
| Example 14 | 100% by weight of treated Globio ® BCB80 (PET), FKUR |
| Comparative | 100% by weight of untreated MOPET-A SSP 0.82+ |
| example 21 | (rPET) from Morssinkhof-Rymoplast |
| Comparative | 50% by weight of untreated and 50% by weight of treated |
| example 22 | MOPET-A SSP 0.82+ (rPET) from Morssinkhof- |
| | Rymoplast |
| Example 15 | 30% by weight of untreated and 70% by weight of treated |
| | MOPET-A SSP 0.82+ (rPET) from Morssinkhof- |
| | Rymoplast |
| Example 16 | 100% by weight of treated MOPET-A SSP 0.82+ (rPET) |
| | from Morssinkhof-Rymoplast |

### Laminate Production

The laminates are produced as described above for the examples and comparative examples with polymer layer P as outer polymer layer. Here too, by the methods specified above, the MFR or intrinsic viscosity of the polymer composition P used for production of the polymer layer P (polymer interlayer here) and the neck-in thereof are ascertained in the melt extrusion coating operation. In addition, what is called the edge waving of the polymer composition P in the melt extrusion coating operation is assessed. The results of the above studies relating to the processability of the polymer compositions P of the examples and comparative examples are summarized in table 10.

TABLE 10
Properties relating to processability of the polymer compositions P of
the examples and comparative examples in which the polymer layer
P is used as polymer interlayer by means of melt extrusion coating

| | | Low | Intrinsic | |
|---|---|---|---|---|
| | | edge | viscosity | MFR |
| | Neck-in [mm] | waving | [dl/g] | [g/10 min] |
| Comparative | 20 | ++ | | 7.5 |
| example 12 | | | | |
| Comparative | 20 | ++ | | 7.5 |
| example 13 | | | | |
| Comparative | not determinable | −− | | 3 |
| example 14 | | | | |
| Comparative | 35 | − | | 4.5 |
| example 15 | | | | |
| Example 9 | 30 | + | | 4.5 |
| Example 10 | 17 | ++ | | 6 |
| Comparative | not determinable | −− | | 10 |
| example 16 | | | | |
| Comparative | 37.5 | − | | 11 |
| example 17 | | | | |
| Example 11 | 32.5 | + | | 11 |
| Example 12 | 22.5 | ++ | | 12 |
| Comparative | not determinable | −− | 0.85 | |
| example 18 | | | | |
| Comparative | not determinable | −− | 0.8 | |
| example 19 | | | | |
| Comparative | 35 | − | 0.79 | |
| example 20 | | | | |
| Example 13 | 30 | + | 0.79 | |
| Example 14 | 25 | ++ | 0.79 | |
| Comparative | not determinable | −− | 0.85 | |
| example 21 | | | | |
| Comparative | 37.5 | − | 0.85 | |
| example 22 | | | | |
| Example 15 | 30 | + | 0.85 | |
| Example 16 | 27.5 | ++ | 0.85 | |

Samples of the polymer interlayer are separated from the laminates from the examples and comparative examples produced as described above, and the ratios therein of the first modulus of elasticity in the first layer direction to the further modulus of elasticity in the further layer direction are determined by the above test method. In the determination of the moduli of elasticity, the first layer direction is always chosen such that this corresponds to the machine direction (MD) of the to extrusion coating operation. Accordingly, the further layer direction is chosen such that it corresponds to cross direction (CD). The results of the further studies are reported in table 11.

TABLE 11
Rheological properties of the polymer layers P of the laminates
from the examples and comparative examples in which
polymer layer P is used as outer polymer layer

| | First modulus of elasticity/further modulus |
|---|---|
| | of elasticity of the polymer layer P |
| Comparative example 12 | 0.93 |
| Comparative example 13 | 0.96 |
| Comparative example 14 | 0.67 |
| Comparative example 15 | 0.80 |
| Example 9 | 0.91 |
| Example 10 | 1.02 |
| Comparative example 16 | 0.61 |
| Comparative example 17 | 0.75 |
| Example 11 | 0.89 |
| Example 12 | 0.97 |
| Comparative example 18 | 0.72 |
| Comparative example 19 | 0.68 |
| Comparative example 20 | 0.79 |
| Example 13 | 0.91 |
| Example 14 | 1.03 |
| Comparative example 21 | 0.69 |
| Comparative example 22 | 0.78 |
| Example 15 | 0.91 |
| Example 16 | 0.98 |

The laminates from the examples and comparative examples produced as described above are examined with regard to adhesion between their barrier layer and their carrier layer by the above test method. In addition, samples of the polymer interlayer are separated, and the biobased carbon content of the polymer interlayer is determined therefrom. The results of the further studies are reported in table 12. In addition, table 12 contains details of the biodegradability and chemical recyclability of the polymer layer P.

TABLE 12
Further properties of the polymer layers P of the laminates from the
examples and comparative examples in which polymer layer P is
used as polymer interlayer

| | Biobased | Bio- | Chemical | Adhesion |
|---|---|---|---|---|
| | carbon | degradability | recyclability | between |
| | content | of the | of the | barrier layer |
| | of polymer | polymer | polymer | and |
| | layer P [%] | layer P | layer P | carrier layer |
| Comparative | 0 | − | − | ++ |
| example 12 | | | | |
| Comparative | 100 | − | − | ++ |
| example 13 | | | | |
| Comparative | 100 | + | + | −− |
| example 14 | | | | |
| Comparative | 100 | + | + | − |
| example 15 | | | | |
| Example 9 | 100 | + | + | + |
| Example 10 | 100 | + | + | + |
| Comparative | 100 | + | + | −− |
| example 16 | | | | |
| Comparative | 100 | + | + | − |
| example 17 | | | | |
| Example 11 | 100 | + | + | + |
| Example 12 | 100 | + | + | ++ |
| Comparative | 0 | − | + | −− |
| example 18 | | | | |
| Comparative | 30 | − | + | − |
| example 19 | | | | |
| Comparative | 30 | − | + | − |
| example 20 | | | | |
| Example 13 | 30 | − | + | + |
| Example 14 | 30 | − | + | + |
| Comparative | 0 (recycled) | − | + | −− |
| example 21 | | | | |
| Comparative | 0 (recycled) | − | + | − |
| example 22 | | | | |
| Example 15 | 0 (recycled) | − | + | + |
| Example 16 | 0 (recycled) | − | + | + |

### Container Production

Closed containers are produced as described above for the examples and comparative examples with the polymer layer P as outer polymer layer. The containers obtained are examined by the method specified above for their leak tightness, and subjected to the opening test described above. The results of these studies are listed in table 13.

TABLE 13
Properties of the containers produced from laminates
according to the examples and comparative
examples with polymer layer P as polymer interlayer

| | Leak tightness | Opening test |
|---|---|---|
| Comparative example 12 | 0 | + |
| Comparative example 13 | 0 | + |
| Comparative example 14 | 151 | −− |
| Comparative example 15 | 63 | − |
| Example 9 | 0 | + |
| Example 10 | 0 | + |
| Comparative example 16 | 203 | − |
| Comparative example 17 | 57 | − |
| Example 11 | 0 | + |
| Example 12 | 0 | + |
| Comparative example 18 | 121 | − |
| Comparative example 19 | 127 | − |
| Comparative example 20 | 46 | − |
| Example 13 | 0 | + |
| Example 14 | 0 | + |
| Comparative example 21 | 211 | − |
| Comparative example 22 | 56 | − |
| Example 15 | 0 | + |
| Example 16 | 0 | + |

### Polymer Layer P as Inner Polymer Layer

In examples 17 to 24 (inventive) and comparative examples 23 to 33 (non-inventive), the layer referred to herein as polymer layer P is used as inner polymer layer. The polymer layer P conforms to the invention here only in the inventive examples.

### Laminate Construction

For the examples (inventive) and comparative examples (non-inventive) in which the polymer layer P is used as inner polymer layer, laminates having the layer construction specified in table 14 below are each prepared by a layer extrusion method.

TABLE 14
Construction of the laminates from the examples and comparative
examples in which polymer layer P is used as inner polymer layer

| | | Basis |
|---|---|---|
| Layer | | weight |
| designation | Material | [g/m²] |
| Outer polymer | LDPE 19N430 from Ineos GmbH, | 15 |
| layer | Cologne, Germany | |
| Carrier layer | Cardboard: Stora Enso Natura T Duplex | 210 |
| | double-coated, Scott bond 200 J/m², | |
| | residual moisture content 7.5% | |
| Polymer | LDPE 23L430 from Ineos GmbH, | 18 |
| interlayer | Cologne, Germany | |
| First adhesion | Escor 6000 HSC from Exxon Mobil | 3 |
| promoter layer | Corporation as adhesion promoter | |
| | polymer A | |
| Barrier layer | aluminum, EN AW 8079 from Hydro | here: |
| | Aluminium Deutschland GmbH | thickness |
| | | 6 μm |
| Second adhesion | Co-extrudate (1) Escor 6000 HSC from | (1)-4 |
| promoter layer | Exxon Mobil Corporation as adhesion | (2)-22 |
| | promoter polymer B, and (2) LDPE | |
| | 19N430 from Ineos GmbH, Cologne, | |
| | Germany | |
| Inner polymer | see Table 15 | 30 |
| layer = | | |
| polymer layer P | | |

### Composition of the Inner Polymer Layer

Table 15 specifies, for each example and comparative example in which polymer layer P is used as inner polymer layer, the compositions used in the polymer layer P and in the polymer composition P from which the polymer layer P is obtained.

TABLE 15
Composition of polymer layer P in the laminates from the
examples and comparative examples in which polymer
layer P is used as inner polymer layer

| | Polymer layer P/polymer composition P |
|---|---|
| Comparative | 100% by weight of untreated LDPE 19N430 from Ineos |
| example 23 | GmbH, Cologne, Germany |
| Comparative | 100% by weight of untreated Braskem LD4000A |
| example 24 | (LDPE) from Braskem |
| Comparative | 100% by weight of untreated Ingeo 4044D (PLA) from |
| example 25 | Nature Works |
| Comparative | 50% by weight of untreated and 50% by weight of |
| example 26 | treated Ingeo 4044D (PLA) from Nature Works |
| Example 17 | 30% by weight of untreated and 70% by weight of treated |
| | Ingeo 4044D (PLA) from Nature Works |
| Example 18 | 100% by weight of treated Ingeo 4044D (PLA) from |
| | Nature Works |
| Comparative | 100% by weight of untreated Biomer B300 (PHB) from |
| example 27 | Biomer |
| Comparative | 50% by weight of untreated and 50% by weight of treated |
| example 28 | Biomer B300 (PHB) from Biomer |
| Example 19 | 30% by weight of untreated and 70% by weight of treated |
| | Biomer B300 (PHB) from Biomer |
| Example 20 | 100% by weight of treated Biomer B300 (PHB) from |
| | Biomer |
| Comparative | 100% by weight of untreated DSM Arnite ® A02 307 |
| example 29 | (PET) |
| Comparative | 100% by weight of untreated Globio ® BCB80 (PET), |
| example 30 | FKUR |
| Comparative | 50% by weight of untreated and 50% by weight of treated |
| example 31 | Globio ® BCB80 (PET), FKUR |
| Example 21 | 30% by weight of untreated and 70% by weight of treated |
| | Globio ® BCB80 (PET), FKUR |
| Example 22 | 100% by weight of treated Globio ® BCB80 (PET), FKUR |
| Comparative | 100% by weight of untreated MOPET-A SSP 0.82+ |
| example 32 | (rPET) from Morssinkhof-Rymoplast |
| Comparative | 50% by weight of untreated and 50% by weight of treated |
| example 33 | MOPET-A SSP 0.82+ (rPET) from Morssinkhof- |
| | Rymoplast |
| Example 23 | 30% by weight of untreated and 70% by weight of treated |
| | MOPET-A SSP 0.82+ (rPET) from Morssinkhof- |
| | Rymoplast |
| Example 24 | 100% by weight of treated MOPET-A SSP 0.82+ (rPET) |
| | from Morssinkhof-Rymoplast |

### Laminate Production

The laminates are produced as described above for the examples and comparative examples with polymer layer P as outer polymer layer. Here too, by the methods specified above, the MFR or intrinsic viscosity of the polymer composition P used for production of the polymer layer P (inner polymer layer here) and the neck-in thereof are ascertained in the melt extrusion coating operation. In addition, what is called the edge waving of the polymer composition P in the melt extrusion coating operation is assessed. The results of the above studies relating to the processability of the polymer compositions P of the examples and comparative examples are summarized in table 16.

TABLE 16
Properties relating to processability of the polymer compositions P of
the examples and comparative examples in which the polymer layer
P is used as inner polymer layer by means of melt extrusion coating

| | | Low | Intrinsic | |
|---|---|---|---|---|
| | | edge | viscosity | MFR |
| | Neck-in [mm] | waving | [dl/g] | [g/10 min] |
| Comparative | 20 | ++ | | 7.5 |
| example 23 | | | | |
| Comparative | 20 | ++ | | 7.5 |
| example 24 | | | | |
| Comparative | not determinable | −− | | 3 |
| example 25 | | | | |
| Comparative | 35 | − | | 4.5 |
| example 26 | | | | |
| Example 17 | 30 | + | | 4.5 |
| Example 18 | 17 | ++ | | 6 |
| Comparative | not determinable | −− | | 10 |
| example 27 | | | | |
| Comparative | 37.5 | − | | 11 |
| example 28 | | | | |
| Example 19 | 32.5 | + | | 11 |
| Example 20 | 22.5 | ++ | | 12 |
| Comparative | not determinable | −− | 0.85 | |
| example 29 | | | | |
| Comparative | not determinable | −− | 0.8 | |
| example 30 | | | | |
| Comparative | 35 | − | 0.79 | |
| example 31 | | | | |
| Example 21 | 30 | + | 0.79 | |
| Example 22 | 25 | ++ | 0.79 | |
| Comparative | not determinable | −− | 0.85 | |
| example 32 | | | | |
| Comparative | 37.5 | − | 0.85 | |
| example 33 | | | | |
| Example 23 | 30 | + | 0.85 | |
| Example 24 | 27.5 | ++ | 0.85 | |

Samples of the polymer interlayer are separated from the laminates from the examples and comparative examples produced as described above, and the ratios therein of the first modulus of elasticity in the first layer direction to the further modulus of elasticity in the further layer direction are determined by the above test method. In the determination of the moduli of elasticity, the first layer direction is always chosen such that this corresponds to the machine direction (MD) of the to extrusion coating operation. Accordingly, the further layer direction is chosen such that it corresponds to cross direction (CD). The results of the further studies are reported in table 17.

TABLE 17
Rheological properties of the polymer layers P of the laminates
from the examples and comparative examples in
which polymer layer P is used as outer polymer layer

| | First modulus of elasticity/further |
|---|---|
| | modulus of elasticity of the polymer layer P |
| Comparative example 23 | 0.93 |
| Comparative example 24 | 0.96 |
| Comparative example 25 | 0.67 |
| Comparative example 26 | 0.80 |
| Example 17 | 0.91 |
| Example 18 | 1.02 |
| Comparative example 27 | 0.61 |
| Comparative example 28 | 0.75 |
| Example 19 | 0.89 |
| Example 20 | 0.97 |
| Comparative example 29 | 0.72 |
| Comparative example 30 | 0.68 |
| Comparative example 31 | 0.79 |
| Example 21 | 0.91 |
| Example 22 | 1.03 |
| Comparative example 32 | 0.69 |
| Comparative example 33 | 0.78 |
| Example 23 | 0.91 |
| Example 24 | 0.98 |

Moreover, the laminates from the examples and comparative examples produced as described above are examined with regard to their propensity to stress-cracking corrosion by the above test method. In addition, samples of the inner polymer layer are separated, and the biobased carbon content of the inner polymer layer is determined therefrom. The results of the further studies are reported in table 18. In addition, table 18 contains details of the biodegradability and chemical recyclability of the polymer layer P.

TABLE 18
Further properties of the polymer layers P of the laminates from the
examples and comparative examples in which polymer
layer P is used as inner polymer layer

| | Biobased | Bio- | Chemical | |
|---|---|---|---|---|
| | carbon content | degradability | recyclability | Stress- |
| | of the polymer | of the polymer | of the polymer | cracking |
| | layer P [%] | layer P | layer P | corrosion |
| Comparative | 0 | − | − | 3 |
| example 23 | | | | |
| Comparative | 100 | − | − | 3 |
| example 24 | | | | |
| Comparative | 100 | + | + | 1 |
| example 25 | | | | |
| Comparative | 100 | + | + | 2 |
| example 26 | | | | |
| Example 17 | 100 | + | + | 3 |
| Example 18 | 100 | + | + | 3 |
| Comparative | 100 | + | + | 1 |
| example 27 | | | | |
| Comparative | 100 | + | + | 2 |
| example 28 | | | | |
| Example 19 | 100 | + | + | 3 |
| Example 20 | 100 | + | + | 3 |
| Comparative | 0 | − | + | 2 |
| example 29 | | | | |
| Comparative | 30 | − | + | 2 |
| example 30 | | | | |
| Comparative | 30 | − | + | 2 |
| example 31 | | | | |
| Example 21 | 30 | − | + | 3 |
| Example 22 | 30 | − | + | 3 |
| Comparative | 0 (recycled) | − | + | 2 |
| example 32 | | | | |
| Comparative | 0 (recycled) | − | + | 2 |
| example 33 | | | | |
| Example 23 | 0 (recycled) | − | + | 3 |
| Example 24 | 0 (recycled) | − | + | 3 |

### Container Production

Closed containers are produced as described above for the examples and comparative examples with the polymer layer P as outer polymer layer. The containers obtained are examined by the method specified above for their leak tightness, and subjected to the opening test described above. The results of these studies are listed in table 19.

TABLE 19
Properties of the containers produced from laminates
according to the examples and comparative examples
with polymer layer P as inner polymer layer

| | Leak tightness | Opening test |
|---|---|---|
| Comparative example 12 | 0 | + |
| Comparative example 13 | 0 | + |
| Comparative example 14 | 250 | −− |
| Comparative example 15 | 176 | − |
| Example 9 | 0 | + |
| Example 10 | 0 | + |
| Comparative example 16 | 250 | − |
| Comparative example 17 | 143 | − |
| Example 11 | 0 | + |
| Example 12 | 0 | + |
| Comparative example 18 | 250 | − |
| Comparative example 19 | 156 | − |
| Comparative example 20 | 46 | − |
| Example 13 | 0 | + |
| Example 14 | 0 | + |
| Comparative example 21 | 250 | − |
| Comparative example 22 | 164 | − |
| Example 15 | 0 | + |
| Example 16 | 0 | + |

The figures respectively show, in schematic form and not to scale, unless stated otherwise in the description or the respective figure:

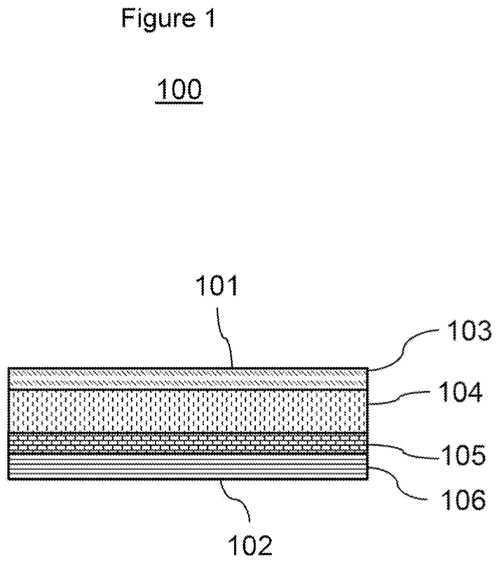

FIG. 1 a schematic diagram of a section of a sheetlike composite of the invention in cross section;

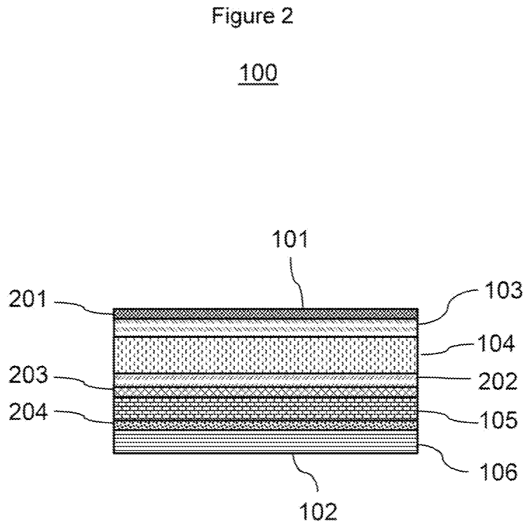

FIG. 2 a schematic diagram of a section of a further sheetlike composite of the invention in cross section;

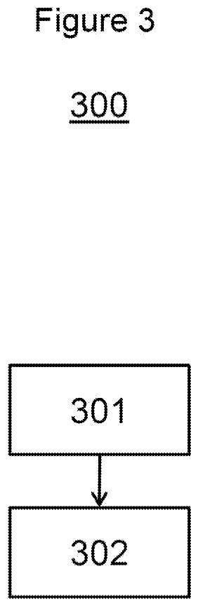

FIG. 3 a flow diagram of a method of the invention for producing a sheetlike composite;

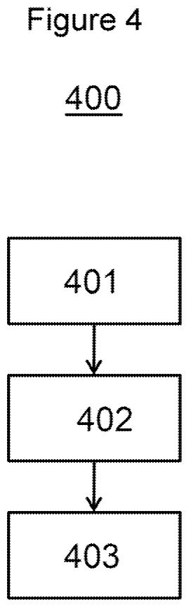

FIG. 4 a flow diagram of a method of the invention for producing a container precursor;

FIG. 5 a schematic diagram of a container precursor of the invention;

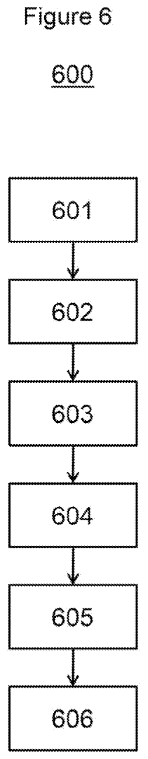

FIG. 6 a flow diagram of a method of the invention for producing a closed container;

FIG. 7 a schematic diagram of a closed container of the invention; and

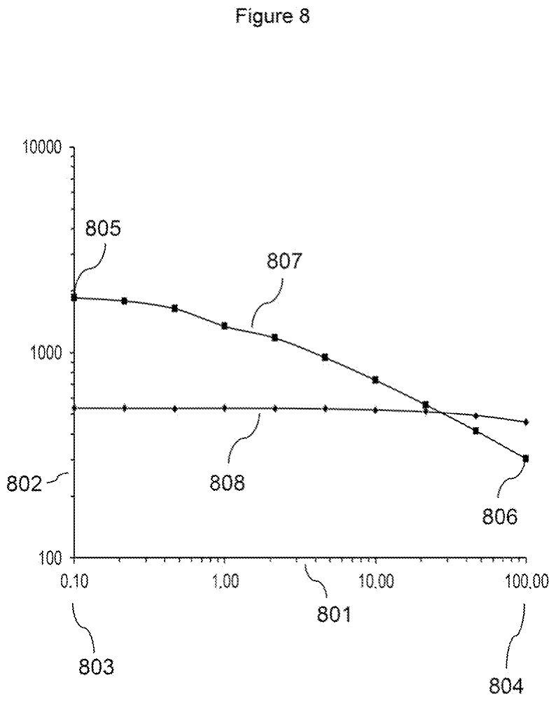

FIG. 8 a diagram of the dependence of the shear viscosity of the polymer layer P on the shear frequency for the polymer layers P of examples 6, 14 and 22, and comparative examples 8, 19 and 30.

FIG. 1 shows a schematic diagram of a section of a sheetlike composite 100 of the invention in cross section. The sheetlike composite 100 consists of the following layers of a layer sequence in the direction from an outer face 101 of the sheetlike composite 100 to an inner face 102 of the sheetlike composite 100: an outer polymer layer 103, a carrier layer 104, a barrier layer 105 and an inner polymer layer 106. The carrier layer 104 is a cardboard layer identified as Stora Enso Natura T Duplex double-coated (Scott bond value 200 J/m², residual moisture content 7.5%). The barrier layer 105 consists of EVOH, available as EVAL L171B from Kuraray, Dusseldorf, Germany. The outer polymer layer 103 and/or the inner polymer layer 106 may be the polymer layer P as described herein. Each polymer layer P comprises a polyester. In addition, each polymer layer P extends two-dimensionally in a respective layer plane and has a first modulus of elasticity in a first layer direction lying in the layer plane, and a further modulus of elasticity in a further layer direction lying in the layer plane. In each case, the first layer direction and corresponding further layer direction are perpendicular to one another. Moreover, a ratio of the first modulus of elasticity to the further modulus of elasticity is within a range from 0.96 to 1.04. If the outer polymer layer 103 is not a polymer layer P, it consists of LDPE 19N430 from Ineos GmbH, Cologne, Germany. If the inner polymer layer 106 is not a polymer layer P, it consists of a blend of 65% by weight of LDPE 19N430 from Ineos GmbH, Cologne, Germany and 35% by weight of Eltex 1315 AZ from Ineos GmbH, Cologne, Germany.

FIG. 2 shows a schematic diagram of a section of a further sheetlike composite 100 of the invention in cross section. The sheetlike composite 100 consists of the following layers in a layer sequence in a direction from an outer face 101 of the sheetlike composite 100 to an inner face 102 of the sheetlike composite 100: an ink application 201 which forms a four-colored decoration, an outer polymer layer 103, a carrier layer 104, a polymer interlayer 202, a first adhesion promoter layer 203, a barrier layer 105, a second adhesion promoter layer 204 and an inner polymer layer 106. The carrier layer 104 is a cardboard layer identified as Stora Enso Natura T Duplex double-coated (Scott bond value 200 J/m², residual moisture content 7.5%). The barrier layer 105 is an aluminum foil having the EN AW 8079 name from Hydro Aluminium Deutschland GmbH. Any or else two or more selected from the group consisting of the outer polymer layer 103, the polymer interlayer 202 and the inner polymer layer 106 may be configured as polymer layer P described herein. The polymer layer P here consists of a polyester which is obtained by treating one of the base polymers specified in table 1 with the chain modifier specified for that purpose. If the outer polymer layer 103 is not a polymer layer P, it consists of LDPE 19N430 from Ineos GmbH, Cologne, Germany. The polymer interlayer 202, if it is not a polymer layer P, consists of LDPE 19N430 from Ineos GmbH, Cologne, Germany. The first adhesion promoter layer 203 and the second polymer layer 204 each consist of EAA Escor 6000 from Exxon Mobil Corporation. If the inner polymer layer 106 is not a polymer layer P, it consists, in a direction from the barrier layer 106 to the inner face 102, of the following three sublayers: a first sublayer composed of 75% by weight of HDPE and 25% by weight of LDPE, based in each case on the total weight of the first sublayer, a second sublayer composed of 100% by weight of LDPE based on the total weight of the second sublayer and a third sublayer composed of a polymer blend, where the polymer blend consists to an extent of 30% by weight of an mPE and to an extent of 70% by weight of an LDPE, based in each case on the total weight of the third sublayer.

FIG. 3 shows a flow diagram of a method 300 of the invention for production of a sheetlike composite 100. In a method step a) 301, a sheetlike composite precursor is provided. This comprises a carrier layer 104. Moreover, a polymer composition P comprising a polyester is provided. In a method step b) 302, the carrier layer 104 is superimposed with the polymer composition P by means of layer extrusion. Accordingly, the polymer composition P is liquid in the superimposing operation. The extrusion coating affords a polymer layer P from the polymer composition P that superimposes the carrier layer 104. This polymer layer P extends two-dimensionally in a layer plane. In one direction lying in the layer plane, in which layer extrusion was effected (machine direction), the polymer layer P has a first modulus of elasticity. In a further layer direction likewise lying within the layer plane, perpendicular to the machine direction, the polymer layer P has a further modulus of elasticity. A ratio of the first modulus of elasticity to the further modulus of elasticity is 1.02.

FIG. 4 shows a flow diagram of a method 400 of the invention for producing a container precursor 500. In a method step a. 401, a blank of the sheetlike composite 100 of FIG. 2 is provided. This blank comprises a first longitudinal rim and a further longitudinal rim. In a method step b. 402, the blank is folded. In a method step c. 403, the first longitudinal rim and the further longitudinal rim are pressed against one another and joined to one another by heat-sealing. Thus, a longitudinal seam 502 is obtained. According to the above description, the container precursor 500 according to FIG. 5 is produced.

FIG. 5 shows a schematic diagram of a container precursor 500 of the invention. The container precursor 500 comprises a blank of the sheetlike composite 100 of FIG. 1 with 4 longitudinal folds 501, each of which forms a longitudinal edge 501. In the container precursor 500, the outer face 101 of the sheetlike composite 100 faces outward. The container precursor 500 is in the form of a shell and comprises a longitudinal seam 502 in which a first longitudinal rim and a further longitudinal rim of the sheetlike composite 100 are sealed to one another. In addition, the container precursor 500 comprises a hole 505 in the carrier layer 104. The hole 505 is covered by the outer polymer layer 103 (not shown), the polymer interlayer 202 (not shown), the barrier layer 105 and the inner polymer layer 106 (not shown) as hole-covering layers. By folding along grooves 506 and joining of fold regions in a top region 503 and a base region 504 of the container precursor 500, a closed container 700 is obtainable. Such a closed container 700 is shown in FIG. 7.

FIG. 6 shows a flow diagram of a method 600 of the invention for producing a closed container 700. In a method step A. 601, the container precursor 500 according to FIG. 5 is provided. In a method step B. 602, a base region 504 of the container precursor 500 is formed by folding the sheetlike composite 100. In a method step C. 603, the base region 504 is closed by sealing with hot air at a temperature of 300° C. In a method step D. 604, the container precursor 500 is filled with a food or drink product 701 and, in a method step E. 605, the container precursor 500 is closed by sealing in a top region 503 to obtain the closed container 700 of FIG. 7. In a method step F. 606, the closed container 700 is joined to an opening aid 702.

FIG. 7 shows a schematic diagram of a closed container 700 of the invention. The closed container 700 has been produced from the container precursor 500 according to FIG. 5. The closed container 700 comprises a food or drink product 701 and has 12 edges 501. In addition, the closed container 700 is connected to a lid comprising an opening aid 702 which covers the hole 505 on the outer face 101 of the sheetlike composite 100. Here, the lid 702 comprises a cutting tool as opening aid in its interior.

FIG. 8 shows a diagram of the dependence of the shear viscosity in Pa·s 802 of the polymer layer P on the shear frequency in rad/s 801 for the polymer layers P of examples 6, 14 and 22, and comparative examples 8, 19 and 30. What are shown are test results obtained by the test method described herein for Globio® BCB80, FKUR 807, treated as described above for the examples, and test results for untreated Globio® BCB80, FKUR 808. For the measurement curve 807 of the polymer layer P of the invention composed of treated Globio® BCB80, the diagram additionally shows the first shear viscosity 805 at the first shear frequency 803 and the further shear viscosity 806 at the further shear frequency 804. It is clearly apparent that the curve 807 shows distinctly greater shear thinning than curve 808 in the range from the first shear frequency 803 of 0.1 rad/s to the further shear frequency 804 of 100 rad/s. In addition, the curve 807 in this region is a non-linear, strictly monotonously decreasing curve of decreasing slope.

### LIST OF REFERENCE NUMERALS

100 Sheetlike composite of the invention
101 Outer face
102 Inner face
103 Outer polymer layer
104 Carrier layer
105 Barrier layer
106 Inner polymer layer
201 Ink application
202 Polymer interlayer
203 First adhesion promoter layer
204 Second adhesion promoter layer
300 Method of the invention for production of a sheetlike composite
301 Method step a)
302 Method step b)
400 Method of the invention for producing a container precursor
401 Method step a.
402 Method step b.
403 Method step c.
500 Container precursor of the invention
501 Longitudinal fold/edge
502 Longitudinal seam
503 Top region
504 Base region
505 Hole
506 Groove
600 Method of the invention for producing a closed container
601 Method step A.
602 Method step B.
603 Method step C.
604 Method step D.
605 Method step E.
606 Method step F.
700 Container of the invention
701 Food or drink product
702 Lid with opening aid
801 Shear frequency in rad/s
802 Shear viscosity in Pa·s
803 First shear frequency
804 Further shear frequency
805 First shear viscosity
806 Further shear viscosity
807 Measurement results for treated Globio® BCB80, FKUR
808 Measurement results for untreated Globio® BCB80, FKUR

1. A sheetlike composite comprising, as mutually superposed layers, in a direction from an outer face of the sheetlike composite to an inner face of the sheetlike composite,
a) a carrier layer, and
b) a barrier layer,
wherein the sheetlike composite additionally comprises a polymer layer P, wherein the polymer layer P
a. comprises a polyester,
b. extends two-dimensionally within a layer plane,
c. has a first modulus of elasticity in a first layer direction which lies in the layer plane, and
d. has a further modulus of elasticity in a further layer direction which lies in the layer plane and is perpendicular to the first layer direction;
wherein a ratio of the first modulus of elasticity to the further modulus of elasticity is within a range from 0.81 to 1.19.

2. The sheetlike composite as claimed in claim 1, wherein the polymer layer P has a melting temperature of more than 145° C.

3. The sheetlike composite as claimed in claim 1, wherein the polymer layer P has a density of more than 1.1 g/cm³.

4. A method comprising, as method steps,
a) providing
i) a sheetlike composite precursor comprising a carrier layer, and
ii) a polymer composition P comprising a polyester; and
b) superimposing the carrier layer with the polymer composition P, thereby obtaining a polymer layer P superimposing the carrier layer;
wherein the polymer layer P
a. extends two-dimensionally within a layer plane,
b. has a first modulus of elasticity in a first layer direction which lies in the layer plane, and
c. has a further modulus of elasticity in a further layer direction which lies in the layer plane and is perpendicular to the first layer direction,
wherein a ratio of the first modulus of elasticity to the further modulus of elasticity is within a range from 0.81 to 1.19.

5. A method comprising, as method steps,
a) providing
i) a sheetlike composite precursor comprising a carrier layer, and
ii) a polymer composition P comprising a polyester; and
b) superimposing the carrier layer with the polymer composition P, thereby obtaining a polymer layer P superimposing the carrier layer;
wherein the polymer composition P is liquid in the superimposing operation in method step b).

6. A sheetlike composite obtainable by the method as claimed in claim 4.

7. A container precursor comprising at least one sheetlike region of the sheetlike composite as claimed in claim 1.

8. A container comprising at least one sheetlike region of the sheetlike composite as claimed in claim 1.

9. A method comprising, as method steps,
a. providing at least one sheetlike region of the sheetlike composite as claimed in claim 1, said at least one sheetlike region comprising a first longitudinal rim and a further longitudinal rim;
b. folding the at least one sheetlike region; and
c. contacting and joining the first longitudinal rim to the further longitudinal rim, thereby obtaining a longitudinal seam.

10. A container precursor obtainable by the method as claimed in claim 9.

11. A method comprising, as method steps:
A. providing the container precursor as claimed in claim 7;
B. forming a base region of the container precursor by folding the sheetlike region;
C. closing the base region;
D. filling the container precursor with a food or drink product; and
E. closing the container precursor in a top region, thereby obtaining a closed container.

12. A closed container obtainable by the method as claimed in claim 11.

13. A use of the sheetlike composite as claimed in claim 1 for production of a food or drink product container.

14. A use of an extruder for reacting of a base polymer with a chain modifier, thereby obtaining a polymer P and for obtaining a sheetlike composite for a food or drink product container by means of melt extrusion coating with the polymer P.

15. A use of a chain modifier for producing a sheetlike composite for a food or drink product container.

16. A use of a mixture comprising a base polymer and a chain modifier for producing a sheetlike composite for a food or drink product container.

17. A use of a base polymer for producing a sheetlike composite for a food or drink product container by means of reacting the base polymer with a chain modifier.

18. A use of a polyester for producing a sheetlike composite for a food or drink product container by means of melt extrusion coating with the polyester.

19. A use of a polyester for producing a sheetlike composite for a food or drink product container,
wherein the sheetlike composite comprises a polymer layer P, comprising the polyester,
wherein the polymer layer P
a. extends two-dimensionally within a layer plane,
b. has a first modulus of elasticity in a first layer direction which lies in the layer plane, and
c. has a further modulus of elasticity in a further layer direction which lies in the layer plane and is perpendicular to the first layer direction,
wherein a ratio of the first modulus of elasticity to the further modulus of elasticity is within a range from 0.81 to 1.19.
